(19) United States
(12) Patent Application Publication
(10) Pub. No.: US 2025/0345877 A1
(43) Pub. Date: Nov. 13, 2025

(54) AUTOMATED GAS TUNGSTEN ARC WELDING SYSTEM FOR FLEXIBLE HOSES

(71) Applicants: T. V. Niranjan Kumar, Bangalore (IN); T. N. Pradeep Kumar Naidu, Bangalore (IN); Shravanthi Sashidhar, Bangalore (IN)

(72) Inventors: T. V. Niranjan Kumar, Bangalore (IN); T. N. Pradeep Kumar Naidu, Bangalore (IN); Shravanthi Sashidhar, Bangalore (IN)

(21) Appl. No.: 19/091,148

(22) Filed: Mar. 26, 2025

(30) Foreign Application Priority Data
May 9, 2024 (IN) 202441036583

(51) Int. Cl. B23K 9/095; B23K 9/12; B23K 9/167; B23K 37/02; B23K 37/0538; B23K 101/06

(52) U.S. Cl. CPC B23K 9/0953; B23K 9/0956; B23K 9/124; B23K 9/167; B23K 37/0229; B23K 37/0538; B23K 2101/06

(57) ABSTRACT

The present disclosure relates to an automated gas tungsten arc welding system for flexible hoses. The Mini Flexi Hose Welder is a breakthrough innovation for welding stainless steel flexible hoses, corrugated hoses, sleeves, and adaptors. Utilizing GTAW with wire feeding, it ensures precise welds on components ranging from 5 mm to 65 mm diameter. Automatic setting capabilities adjust height, diameter, and offsets, enhancing accuracy. Cloud monitoring enables real-time monitoring of welded components. Energy-efficient at <400 W, its compact user-friendly design offers an out-of-the-box automated solution. Addressing limitations of traditional welding for flexible hoses, this system caters to industries requiring high-quality, efficient welding of these components. Its specialized features, including automatic settings, cloud monitoring, and energy efficiency, make it a versatile and reliable choice for welding flexible hoses.

### CROSS-REFERENCE TO RELATED APPLICATION

This application claims the benefit of and priority to Indian Patent Application number 202441036583 filed May 9, 2024, the contents of which being incorporated by reference in their entirety herein.

### FIELD OF THE DISCLOSURE

The present disclosure relates to a welding automation system enabling seamless welding of the components, specifically to an automated gas tungsten arc welding system for flexible hoses.

### BACKGROUND

Welding of flexible hoses has traditionally been a challenging and often imprecise process due to several inherent drawbacks associated with existing welding techniques and equipment. These drawbacks have hindered the ability to achieve reliable and consistent welds on flexible hoses, sleeves, adaptors, and related components.

One significant drawback is the lack of specialized welding machines designed specifically for flexible hoses. Conventional welding machines are primarily intended for welding rigid components and struggle to accommodate the unique geometries and flexibility of hoses. The curvatures, bends, and varying diameters of flexible hoses make it difficult for traditional welding machines to maintain proper positioning and alignment during the welding process, leading to improper fusion and potential structural weaknesses.

Another drawback is the difficulty in handling and manipulating flexible hoses during welding. These components are designed to be flexible and mobile, which can cause them to shift or move during the welding process, resulting in imprecise welds. Operators often struggle to maintain the proper positioning and alignment, leading to inconsistent weld quality and potential failures.

Furthermore, existing welding techniques, such as Gas Tungsten Arc Welding (GTAW) or Shielded Metal Arc Welding (SMAW), may not be optimized for welding flexible hoses. These methods can introduce excessive heat input, which can damage the delicate materials used in flexible hoses, such as rubber or plastic liners, compromising their integrity and performance.

Additionally, traditional welding processes often lack automated features and rely heavily on skilled operators, making it challenging to achieve consistent and repeatable results. Manual processes are prone to human error and variations, further contributing to quality inconsistencies.

The lack of specialized welding equipment and techniques tailored for flexible hoses has limited the ability to produce high-quality, reliable welds on these components. This has posed significant challenges for manufacturers in various industries that rely on flexible hoses, such as automotive, aerospace, and industrial machinery, where failure can have severe consequences.

To address these drawbacks and meet the growing demand for reliable and efficient welding solutions for flexible hoses, the mini flexi hose welder was developed. This innovative machine incorporates specialized features and capabilities specifically designed to overcome the limitations of traditional welding methods and equipment when working with flexible hoses, sleeves, adaptors, and related components.

### BRIEF SUMMARY

The present disclosure relates to an automated gas tungsten arc welding system for flexible hoses. The Mini Flexi Hose Welder is a groundbreaking innovation designed specifically for welding stainless steel flexible hoses, corrugated flexible hoses, along with their sleeves and adaptors. This advanced system employs the Gas Tungsten Arc Welding (GTAW) method with wire feeding, ensuring precise and reliable welds on hoses with diameters ranging from 5 mm to 65 mm (approximately ¼ to 2½ inches). One of the key features of this disclosure is its automatic setting capability, which adjusts the height, diameter, and offsets, enhancing convenience and accuracy during operation. The integration of cloud monitoring technology sets this welding system apart from others, enabling real-time monitoring of every welded component, ensuring quality control and traceability. The Mini Flexi Hose Welder boasts an energy-efficient design, consuming less than 400 W of power, making it an environmentally friendly solution. Additionally, it comes as a user-friendly out-of-the-box module, facilitating easy setup and operation. This compact and automated welding system aims to provide the best automation solution for various industries that require high-quality, efficient welding solutions for flexible hoses. Its advanced features, such as automatic setting capabilities, cloud monitoring technology, and energy efficiency, make it a versatile and reliable choice for welding applications in diverse sectors. Overall, the Mini Flexi Hose Welder represents a significant advancement in the field of welding, offering a specialized and automated solution for the welding of flexible hoses, sleeves, and adaptors, while prioritizing precision, efficiency, and environmental sustainability.

In an embodiment, a gas tungsten arc welding (GTAW) system for automated welding of flexible hoses is disclosed. The system includes a frame having a pneumatic stopper assembly, pneumatically connected to an air supply, configured to position and secure flexible hoses for fusion welding at a user-defined location.

The system further includes a wire feed spool, connected to the frame, configured to supply welding wire.

The system further includes an auto pneumatic connector fixture assembly, pneumatically connected to the air supply and electrically connected to a control panel, comprising an EC copper-based fixture holder, the fixture assembly configured to align and secure connectors concentrically with fusion-welded hoses for wire feed welding, and controlled via an HMI/touch screen.

The system further includes a purging assembly, fluidly connected to a gas source, configured to introduce a backflow gas into a weld joint between a connector and a fusion-welded hose during wire feed welding, thereby minimizing oxidation and discoloration.

The system further includes a torch and wire feed holder kit, mechanically coupled to a motorized Z-axis, Y-axis, and X-axis, configured to position a GTAW welding torch and a wire feed adapter.

The system further includes a fixture adapter, mechanically coupled to the auto pneumatic connector fixture assembly, configured to accommodate fixtures for connector assembly with varying diameters ranging from ¼ inch to 2 inches.

The system further includes a motorized Z-axis, electrically connected to the control panel, configured to automatically position the GTAW welding torch along a vertical axis.

The system further includes a motorized Y-axis, electrically connected to the control panel, configured to automatically position the GTAW welding torch along a horizontal lateral axis.

The system further includes a motorized X-axis, electrically connected to the control panel, configured to automatically position the GTAW welding torch along a horizontal longitudinal axis.

The system further includes a motorized R-axis, electrically connected to the control panel, configured to rotate a workpiece clamped in a chuck up to 600 degrees, facilitating welding, pre-purge, post-purge, overlap, and post-weld cooling processes.

The system further includes a motorized wire feed axis, electrically connected to the control panel and mechanically coupled to the wire feed spool, configured to automatically position the wire feed for connector welding.

The system further includes a tower lamp, electrically connected to the control panel, configured to indicate operational status, including welding and emergency stop conditions, using color indicators and a buzzer.

The control panel comprising a programmable logic controller (PLC) further configured to control the movement of the motorized R-axis to execute a variable rotational speed profile during the welding process, wherein the rotational speed is dynamically adjusted based on the angular position of the workpiece to maintain a consistent weld bead formation, thereby enabling the welding of complex geometries, control the welding machine to vary the welding current in real-time based on the angular position of the workpiece as determined by the motorized R-axis, thus ensuring uniform weld penetration and heat distribution across the weld joint, execute a pre-programmed welding sequence that includes dynamic adjustment of the motorized X-axis, Y-axis, and Z-axis positions, wherein the adjustment is based on a taught welding path that defines a series of coordinate points and associated welding parameters, thereby enabling precise control of the GTAW welding torch, and control the motorized wire feed axis to synchronize the wire feed rate with the movement of the GTAW welding torch, wherein the synchronization is achieved by correlating the wire feed rate to the instantaneous velocity of the X-axis, Y-axis, and Z-axis, thus ensuring consistent weld filler deposition.

The system further includes a cloud monitoring module, configured to provide real-time monitoring of welding parameters and welded components.

The system further includes wherein the HMI/touch screen is electrically connected to the control panel, configured to enable user interface for program teaching and parameter settings. The welding machine is electrically connected to the control panel and mechanically coupled to the torch and wire feed holder kit, configured to perform gas tungsten arc welding (GTAW) welding operations.

An objective of the present disclosure is to provide an automated welding system specifically designed for welding stainless steel flexible hoses, corrugated flexible hoses, sleeves, and adaptors with diameters ranging from 5 mm to 65 mm.

Another objective of the present disclosure is to employ the Gas Tungsten Arc Welding (GTAW) method with wire feeding to ensure precise and reliable welds on flexible hoses and associated components.

Another objective of the present disclosure is to offer automatic setting capabilities for height, diameter, and offsets, enhancing convenience and accuracy during the welding process.

Another objective of the present disclosure is to integrate cloud monitoring technology for real-time monitoring of every welded component, enabling quality control and traceability.

Another objective of the present disclosure is to provide an energy-efficient welding solution, consuming less than 400 W of power, promoting environmental sustainability.

Another objective of the present disclosure is to offer a user-friendly out-of-the-box module, facilitating easy setup and operation of the Mini Flexi Hose Welder system.

Yet, another objective of the present disclosure is to cater to the needs of various industries requiring high-quality, efficient welding solutions for flexible hoses, sleeves, and adaptors in a compact and automated package.

To further clarify advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a diagram representing the standard mini flexi hose setup in accordance with an embodiment of the present disclosure;

FIG. 2 illustrates a schematic diagram of the mini flex hose machine in accordance with an embodiment of the present disclosure;

FIG. 3 illustrates an exemplary profile of a gas tungsten arc welding (GTAW) system for automated welding of flexible hoses in accordance with an embodiment of the present disclosure; and

FIG. 4 illustrates a block diagram of gas tungsten arc welding (GTAW) system for automated welding of flexible hoses in accordance with an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Embodiments of the present disclosure will be described below in detail with reference to the accompanying drawings.

The present disclosure relates to an automated gas tungsten arc welding system for flexible hoses. The Mini Flexi Hose Welder is an innovative automated welding system designed specifically for welding stainless steel flexible hoses, corrugated hoses, sleeves, and adaptors with diameters ranging from 5 mm to 65 mm. It utilizes the GTAW (Gas Tungsten Arc Welding) method with wire feeding for precise and reliable welds. Key features include automatic setting capabilities for height, diameter, and offsets, as well as cloud monitoring technology for real-time monitoring of welded components. With an energy-efficient design consuming less than 400 W and a user-friendly out-of-the-box module, this compact system provides an automated welding solution tailored for flexible hoses in various industries.

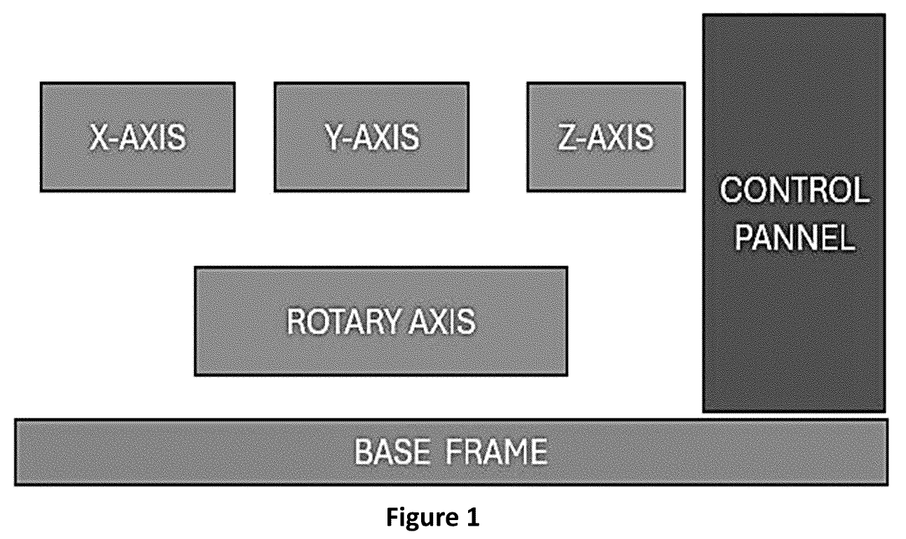

FIG. 1 illustrates a diagram representing the standard mini flexi hose setup in accordance with an embodiment of the present disclosure.

The Mini Flexi Hose Welder is a highly advanced and precise welding system designed specifically for welding flexible hoses. At the heart of this machine lies its sophisticated motion control system, which features a total of five axes for precise movement control during welding operations.

Three of these axes are linear axes, denoted as X, Y, and Z, each with an impressive stroke length of 150 units. This extensive range of motion allows for flexible positioning of the welding torch, enabling it to reach and weld even the most intricate geometries and configurations of flexible hoses. The fourth axis is a rotary axis designed for circular movement, which serves a crucial role in securely holding and rotating the flexible hose during the welding processes. The fifth axis is dedicated to the wire feeder, ensuring a smooth and consistent wire feed during the Gas Tungsten Arc Welding (GTAW) process.

Mounted to the Z-axis is the weld torch itself, which performs the actual welding operation. This strategic placement, combined with the precision of the motion control system, ensures that the welding torch can be positioned with pinpoint accuracy, resulting in consistently high-quality welds.

Controlling this advanced system is a user-friendly control panel that facilitates precise control over the positioning of each axis. Operators can easily teach the machine for automated welding tasks, programming intricate movements and sequences tailored to the specific requirements of the flexible hose being welded.

At the core of the control panel lies a robust Programmable Logic Controller (PLC) programming system. This powerful programming architecture offers a reliable and efficient means of controlling the machine's movements and welding processes. Through PLC programming, operators can set specific welding parameters, adjust axis positions, and create automated welding sequences, ensuring consistent and high-quality welds every time.

Furthermore, the PLC programming also serves as a valuable tool for troubleshooting and maintenance. By providing detailed diagnostics and monitoring capabilities, the system allows for easy identification and resolution of any issues that may arise, minimizing downtime and ensuring smooth, uninterrupted operation of the Mini Flexi Hose Welder.

The combination of its five-axis motion control system, precise weld torch positioning, user-friendly control panel, and powerful PLC programming make the Mini Flexi Hose Welder a truly innovative and efficient solution for welding flexible hoses, setting new standards for precision, reliability, and ease of use in this specialized field.

The working process of the Mini Flexi Hose Welder begins with the setup phase, where the component to be welded is carefully placed on the rotary axis. The Z-axis, which houses the welding torch, is then precisely positioned in relation to the component, ensuring optimal alignment for the welding operation.

Once the setup is complete, the teaching process commences. This critical step involves using the control panel to initially position the axes, aligning the welding torch with the intended weld seam. The operator then activates the teaching mode on the control panel, enabling manual guidance of the X, Y, and Z axes.

With the teaching mode activated, the operator takes control, manually moving the axes to trace the desired welding path. As the operator guides the axes along the intended trajectory, the PLC programming records the precise positions of each axis, effectively “teaching” the machine the intricate movements required for the weld.

Upon completing the teaching process, the operator initiates the auto weld feature from the control panel. This powerful feature hands over control to the PLC programming, which now governs the movement of the Mini Flexi Hose axes along the recorded path. With remarkable precision, the axes move in sync with the programmed trajectory, ensuring that the weld torch follows the predefined path accurately.

As the Mini Flexi Hose moves along the programmed path, the weld torch emits the welding arc, melting the base materials and creating the desired weld seam. Throughout this process, the operator closely monitors the operation, ensuring that the weld quality meets the required standards.

Once the auto weld feature completes the programmed path, the welding process is finished. The component can then be carefully removed from the rotary axis, and the next welding operation can begin if needed.

The combination of the teaching process and the auto weld feature allows for unparalleled precision and efficiency in welding components using the Mini Flexi Hose Welder. The operator's manual guidance during the teaching mode, combined with the PLC programming's accurate execution during the auto weld phase, ensures consistent and high-quality welds every time.

This innovative working process, facilitated by the advanced motion control system, user-friendly control panel, and powerful PLC programming, sets the Mini Flexi Hose Welder apart as a cutting-edge solution for welding intricate and complex components, particularly in the realm of flexible hoses and related assemblies.

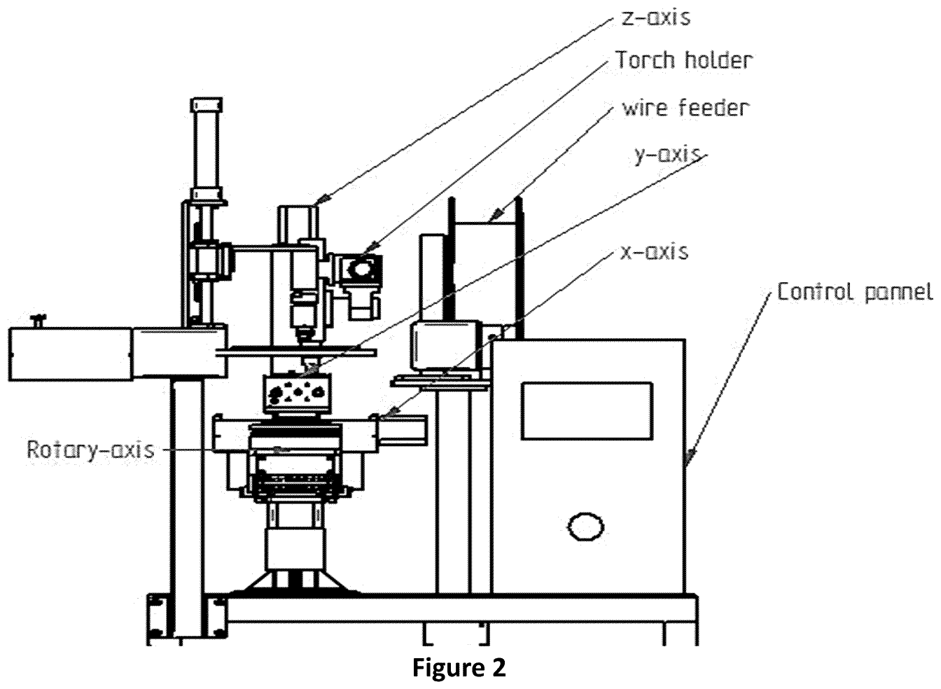

FIG. 2 illustrates a schematic diagram of the mini flex hose machine in accordance with an embodiment of the present disclosure.

The Mini Flexi Hose Welder is an advanced and cutting-edge welding solution specifically designed for welding stainless steel flexible hoses or corrugated flexible hoses, along with their sleeves and adaptors. This state-of-the-art system is capable of handling components with diameters ranging from 5 mm to 65 mm (approximately ¼ to 2½ inches).

The system involves Gas Tungsten Arc Welding (GTAW) method, which is employed in conjunction with wire feeding to ensure precise and reliable welds. One of the standout features of the Mini Flexi Hose Welder is its automatic setting capability, which automatically adjusts the height, diameter, and offsets during the welding process, enhancing precision and efficiency.

Pushing the boundaries of technology, the Mini Flexi Hose Welder boasts the world's most advanced cloud monitoring technology. This cutting-edge feature enables real-time monitoring of every welded component, ensuring unparalleled quality control and traceability throughout the welding process.

In addition to its advanced capabilities, the Mini Flexi Hose Welder is designed with energy efficiency in mind. With a remarkably low power consumption of less than 400 W, this system offers a sustainable and environmentally friendly solution. Furthermore, it comes as a user-friendly out-of-the-box module, facilitating easy setup and operation, making it an optimal automation solution in a compact package.

The Mini Flexi Hose Welder is equipped with a range of advanced features that set it apart from traditional welding systems. These include faster and smoother movement, a touch human-machine interface for enhanced user experience, and a load capacity of up to 8 kgs, allowing for versatile welding applications.

Additionally, the system features additional input and output modules for safety systems and axis expansion, ensuring a safe and flexible welding environment. It also introduces the new and improved NIKIT Teach User Interface, which enhances usability and productivity, streamlining the welding process.

One of the standout features of the Mini Flexi Hose Welder is its integration with a 200 KHz high-speed optical isolated design IP/OP and IIOT module. This module enables online data and alert monitoring, facilitating seamless data logging and machine process alert management. Furthermore, it allows for program upgrades to be performed online, ensuring that the system remains up-to-date with the latest advancements.

The machine Data Logger represents a significant technological advancement in welding and machine data collection. This micro-controller-based system is designed to measure and document all basic machine parameters, providing comprehensive data for analysis and optimization.

The Mini Flexi Hose Welder's cloud-based monitor offers flexibility in connectivity, supporting both Ethernet and cellular network connections. Setup is straightforward and can be completed through a web browser, ensuring a seamless integration into existing infrastructure.

The monitoring capabilities of the Mini Flexi Hose Welder are extensive, offering both basic and advanced features. These include operator data logging, air pressure monitoring, error and sequence reports, machine data logging, weld cycle limits, wire feed monitoring, maintenance monitoring, purging enable/disable, camera monitoring system, remote monitoring, LAN module, gas pressure monitoring, and input and output monitoring. These features ensure comprehensive monitoring and analysis of the welding process, enabling continuous improvement and optimization.

The MFHW-O-V6.1 model of the Mini Flexi Hose Welder boasts impressive specifications, including compact dimensions of 400 mm×400 mm×400 mm. The X-axis features a stroke of 150 mm with 360-degree rotation, allowing for versatile positioning and welding of complex geometries. The system offers a weld speed of 10 degrees per second and manual torch height adjustment of 100 mm, providing flexibility and precision during the welding process.

Furthermore, the MFHW-O-V6.1 model exhibits remarkable accuracy, with an axis repeatability of +/−0.2 mm and an interpolation repeatability of +/−0.1 mm, ensuring consistent and high-quality welds every time. The system is equipped with a user-friendly 4-inch touch user interface screen, enhancing the overall user experience and ease of operation.

The Mini Flexi Hose Welder represents a significant technological advancement in the field of welding, offering a specialized and highly efficient solution for welding flexible hoses, sleeves, and adaptors. With its advanced features, cloud monitoring capabilities, energy efficiency, and user-friendly design, this system sets a new standard for precision, reliability, and ease of use in the welding industry.

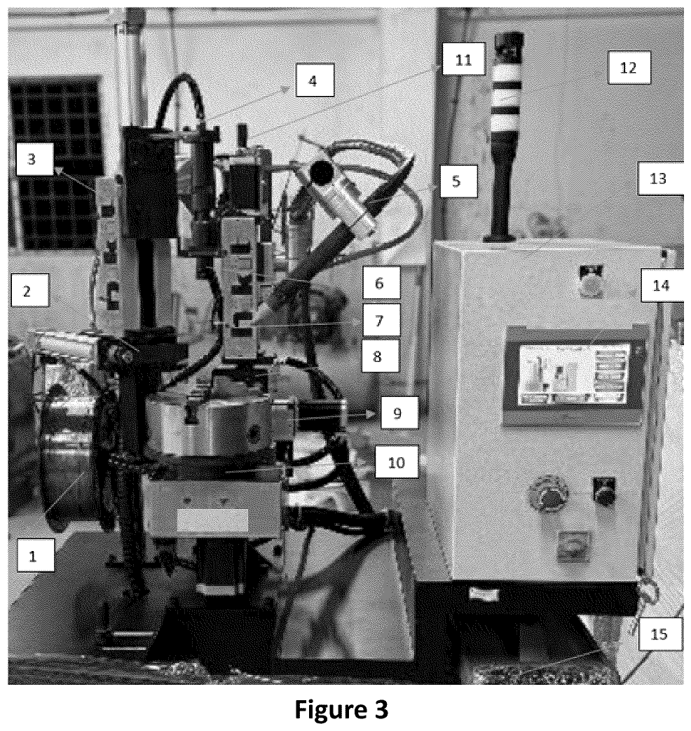

FIG. 3 illustrates an exemplary profile of a gas tungsten arc welding (GTAW) system for automated welding of flexible hoses in accordance with an embodiment of the present disclosure.

### List of Parts/Assemblies:

1. Wirefeed Spool, to weld the connectors we need wire spool generally the materials of the wire can range from 304 to 316. For any connector welding after fusion weld on the sleeve the connector needs additional filling for both the connector and the sleeve to join together.
2. Manual Pneumatic Stopper Assembly, the one that stops and positions all the hoses to make sure the fusion welding happens exactly at the same spot every single time. Basically to keep all the hoses loaded on the machine at a certain fixed level of welding.
3. Auto Pneumatic Connector fixture Assembly, makes sure that the fixtures for all the connector welding are held in position in this EC copper based fixture holder that is deployed via the HMI/Touchscreen and this pushes down the connector onto to the fusion welded hose thus making sure that the connector is perfectly aligned concentrically to the hose for perfect connector wirespool welding in TIG process.
4. Purging Assembly, ensures that when the stopper assembly along with the connecter comes down to hold the connector with the fusion welded hose, this system purges the backflow gas into the weld joint between these two, thus making sure that during connector welding process there is least oxidation and the weld bead penetration discoloration is minimal and acceptable according to AWS standards.
5. Torch & Wirefeed Holder Kit, is the one that holds the TIG welding torch and the wirefeed adaptor in position. This has multiple connectors and tube holder that are engraved for quick and easy positioning during manual adjustment.
6. Fixture Adaptor, is where all the different diameters ranging from ¼ inch to 2 inch fixtures for connector assembly be attached for welding.
7. Motorised Z axis, is for auto positioning of the torch in Z direction.
8. Motorised Y axis, is for auto positioning of the torch in Y direction.
9. Motorised X axis, is for auto positioning of the torch in X direction.
10. Motorised R axis, is for rotating the job clamped in the chuck for upto 600 deg. This includes, welding, pre & post-purge, overlap and post weld cooling process.
11. Motorised Wirefeed axis, is for auto positioning of the wire feed for welding the connectors.
12. Tower lamp, indicates the status of operation of the machine, right from welding on to emergency stop, it comes with three color indicators, orange, red and green. It also has a buzzer for critical emergencies.
13. Control Panel, has all the drives, smps, isolation device, electrical connections and the main controller with the HMI.
14. HMI/Touch Screen, is for all the User Interface to happen, to set right from teach of the program to parameter settings. The sequence is self-explanatory in the manual.
15. Welding Machine, for welding of the components.

The developed disclosure provides key features are:
a. Setting Variable Current at variable Angles
b. Setting Variable Speed for various angles.
c. Auto positioning and welding of both fusion and wirefeed in the same machine.
d. Stopper assembly to set auto positions for fusion welding of the sleeves.
e. Inbuilt Auto pneumatic connector holding fixture with pressure adjustment to set the wire feed welding.
f. Auto purging kit to make sure the purge gas positioning is exactly at the connector and sleeve weld joint.
g. WPS, Weld Process Sheet which is AWS standard for welding is inbuilt into the system to take the right data for welding and setting the parameters for different hoses.
h. Data logging & Cloud Monitoring, is inbuilt to track the parameters of the system.

In an embodiment, the present disclosure provides a method for automated gas tungsten arc welding (GTAW) of flexible hoses using an automated welding system as claimed in claim 1, the method comprising: positioning and securing a flexible hose at a user-defined location using a pneumatic stopper assembly pneumatically connected to an air supply; supplying welding wire from a wire feed spool connected to the welding system frame; concentrically aligning and securing a connector to the fusion-welded hose using an auto pneumatic connector fixture assembly comprising an EC copper-based fixture holder, the fixture assembly being pneumatically and electrically actuated via a control panel and a human-machine interface (HMI); introducing a purging gas to a weld joint between the connector and the hose using a purging assembly fluidly connected to a gas source to minimize oxidation and discoloration during wire feed welding; positioning a GTAW welding torch and wire feed adapter using a torch and wire feed holder kit mechanically actuated by motorized Z-axis, Y-axis, and X-axis stages; adapting the fixture assembly using a fixture adapter to accommodate connector diameters ranging from ¼ inch to 2 inches; automatically moving the GTAW welding torch along vertical, lateral, and longitudinal axes using motorized Z-axis, Y-axis, and X-axis actuators respectively, under control of the control panel; rotating the clamped workpiece using a motorized R-axis up to 600 degrees to facilitate welding, purging, overlap, and cooling steps; automatically positioning the wire feed using a motorized wire feed axis mechanically coupled to the wire feed spool; indicating the operational status, including welding and emergency stop, using a tower lamp electrically connected to the control panel; dynamically adjusting the rotational speed of the motorized R-axis based on the angular position of the workpiece to maintain consistent weld bead formation; varying the welding current in real-time based on the angular position of the workpiece to ensure uniform weld penetration and heat distribution; executing a pre-programmed welding sequence comprising coordinated movement of the X, Y, and Z motorized axes along a taught welding path defining coordinate points and associated welding parameters; and synchronizing the wire feed rate with the instantaneous velocity of the X, Y, and Z axes to ensure consistent filler material deposition.

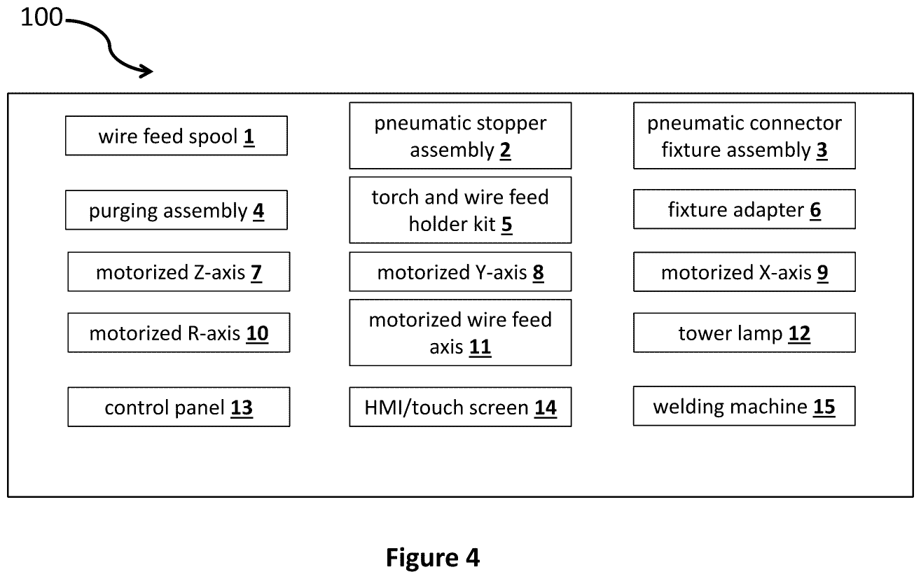

FIG. 4 illustrates a block diagram of gas tungsten arc welding (GTAW) system for automated welding of flexible hoses in accordance with an embodiment of the present disclosure. The system 100 includes a frame having a pneumatic stopper assembly (2), pneumatically connected to an air supply, configured to position and secure flexible hoses for fusion welding at a user-defined location.

In an embodiment, a wire feed spool (1) is connected to the frame, configured to supply welding wire.

In an embodiment, an auto pneumatic connector fixture assembly (3) is pneumatically connected to the air supply and electrically connected to a control panel, comprising an EC copper-based fixture holder, the fixture assembly configured to align and secure connectors concentrically with fusion-welded hoses for wire feed welding, and controlled via an HMI/touch screen.

In an embodiment, a purging assembly (4) is fluidly connected to a gas source, configured to introduce a backflow gas into a weld joint between a connector and a fusion-welded hose during wire feed welding, thereby minimizing oxidation and discoloration.

In an embodiment, a torch and wire feed holder kit (5) is mechanically coupled to a motorized Z-axis, Y-axis, and X-axis, configured to position a GTAW welding torch and a wire feed adapter.

In an embodiment, a fixture adapter (6) is mechanically coupled to the auto pneumatic connector fixture assembly, configured to accommodate fixtures for connector assembly with varying diameters ranging from ¼ inch to 2 inches.

In an embodiment, a motorized Z-axis (7) is electrically connected to the control panel, configured to automatically position the GTAW welding torch along a vertical axis.

In an embodiment, a motorized Y-axis (8) is electrically connected to the control panel, configured to automatically position the GTAW welding torch along a horizontal lateral axis.

In an embodiment, a motorized X-axis (9) is electrically connected to the control panel, configured to automatically position the GTAW welding torch along a horizontal longitudinal axis.

In an embodiment, a motorized R-axis (10) is electrically connected to the control panel, configured to rotate a workpiece clamped in a chuck up to 600 degrees, facilitating welding, pre-purge, post-purge, overlap, and post-weld cooling processes.

In an embodiment, a motorized wire feed axis (11) is electrically connected to the control panel and mechanically coupled to the wire feed spool, configured to automatically position the wire feed for connector welding.

In an embodiment, a tower lamp (12) is electrically connected to the control panel, configured to indicate operational status, including welding and emergency stop conditions, using color indicators and a buzzer.

The control panel (13) comprising a programmable logic controller (PLC) further configured to control the movement of the motorized R-axis (10) to execute a variable rotational speed profile during the welding process, wherein the rotational speed is dynamically adjusted based on the angular position of the workpiece to maintain a consistent weld bead formation, thereby enabling the welding of complex geometries, control the welding machine (15) to vary the welding current in real-time based on the angular position of the workpiece as determined by the motorized R-axis (10), thus ensuring uniform weld penetration and heat distribution across the weld joint, execute a pre-programmed welding sequence that includes dynamic adjustment of the motorized X-axis (9), Y-axis (8), and Z-axis (7) positions, wherein the adjustment is based on a taught welding path that defines a series of coordinate points and associated welding parameters, thereby enabling precise control of the GTAW welding torch, and control the motorized wire feed axis (11) to synchronize the wire feed rate with the movement of the GTAW welding torch, wherein the synchronization is achieved by correlating the wire feed rate to the instantaneous velocity of the X-axis (9), Y-axis (8), and Z-axis (7), thus ensuring consistent weld filler deposition.

In an embodiment, a cloud monitoring module is configured to provide real-time monitoring of welding parameters and welded components.

The HMI/touch screen (14) is electrically connected to the control panel, configured to enable user interface for program teaching and parameter settings. The welding machine (15) is electrically connected to the control panel and mechanically coupled to the torch and wire feed holder kit, configured to perform gas tungsten arc welding (GTAW) welding operations.

In another embodiment, pneumatic stopper assembly (2) further comprising a closed-loop pneumatic control system to maintain a constant clamping force on the flexible hoses, wherein the clamping force is monitored and adjusted in real-time to compensate for variations in hose diameter and material properties, thereby ensuring repeatable positioning.

In another embodiment, the pneumatic stopper assembly (2) further comprises a closed-loop pneumatic control system designed to maintain a constant and precisely regulated clamping force on flexible hoses during the welding process. This system operates through an integration of pneumatic actuators, high-precision pressure sensors, and a digital control unit configured with a real-time feedback loop. The core principle of the closed-loop system lies in the continuous monitoring and dynamic adjustment of clamping pressure to adapt to variations in hose diameters and material properties such as elasticity, wall thickness, and compressibility. For example, a hose composed of a thermoplastic elastomer with a variable diameter due to temperature-induced expansion would be clamped with the same effective force as a more rigid silicone-based hose with a consistent diameter.

The control system utilizes a proportional-integral-derivative (PID) algorithm to interpret real-time sensor feedback and compare the actual clamping force to a predefined setpoint derived from stored clamping force profiles associated with specific hose types. Based on this comparison, the system modulates the pneumatic actuator pressure using an electronically controlled proportional valve to increase or decrease the air pressure applied. This ensures that the mechanical deformation of the hose is uniform and does not cause ovality or slippage during the welding operation, thereby ensuring repeatable positioning. Moreover, to enhance responsiveness, the control system operates at a high sampling frequency (e.g., 1 kHz), allowing sub-second adjustments in pressure, even during thermal expansion or contraction of the hose during adjacent welding activities. The combination of real-time feedback, predictive control algorithms, and adaptive pressure regulation ensures that each hose is clamped consistently, regardless of environmental conditions or minor part-to-part variations, thus forming a critical component for the accuracy and repeatability of the automated welding system.

In a further embodiment, the auto pneumatic connector fixture assembly (3) further comprising a pressure regulation system that allows for adjustable clamping force on the connectors, wherein the clamping force is set based on the connector material and geometry to prevent deformation during the welding process and a sensor feedback loop to confirm the connector is in the correct location prior to welding, and will not allow welding to proceed if the connector is not in the correct location, wherein the sensor feedback loop is further configured to perform a pre-weld dimensional analysis of the connector using a laser micrometer, wherein the dimensional analysis is compared to stored connector specifications to verify dimensional accuracy, preventing welding on defective connectors and utilize an eddy current sensor to verify the material composition of the connector, wherein the material composition verification is used to select the correct welding parameters from the stored WPS, ensuring optimal weld quality.

In a further embodiment, the auto pneumatic connector fixture assembly (3) is enhanced with a sophisticated pressure regulation system that enables precise, adjustable clamping force on the connectors during the automated welding process. This pressure regulation system integrates programmable electro-pneumatic regulators that control the air pressure applied to pneumatic cylinders based on pre-calibrated force thresholds. These thresholds are defined in the system's database and are mapped to specific connector materials—such as aluminum, stainless steel, or copper alloys—and geometries, including round, flared, or stepped connectors. By automatically selecting the appropriate clamping force for a given connector, the system effectively prevents structural deformation during welding, especially critical for thin-walled or malleable connectors.

To ensure the connector is properly seated prior to the welding sequence, the system employs a multi-stage sensor feedback loop. This includes proximity sensors for coarse positioning verification, followed by high-precision alignment checks performed by a laser micrometer. The laser micrometer conducts a pre-weld dimensional analysis, generating a real-time 3D profile of the connector's outer geometry. This profile is compared against stored dimensional tolerances in the system's database, where each connector's specification, including diameter, shoulder length, and flange thickness, is cataloged. If the dimensional analysis falls outside of acceptable limits—indicating a possible manufacturing defect or incorrect part—the system disables the welding torch initiation, thereby avoiding substandard welds and subsequent product failure.

Additionally, the fixture assembly integrates an eddy current sensor for non-destructive verification of the connector's material composition. The eddy current sensor induces localized electromagnetic fields into the connector and measures the resulting impedance characteristics, which are material-specific. These measurements are compared to a reference library to confirm the alloy grade of the connector. Once verified, the control panel retrieves the corresponding welding procedure specification (WPS) stored in the system's memory. This WPS includes critical welding parameters such as arc current, voltage, travel speed, shielding gas composition, and wire feed rate-all optimized for the verified material.

This layered system of force regulation, positional and dimensional verification, and material authentication ensures a fully automated, quality-assured welding process that minimizes operator dependency and eliminates welding of improperly aligned, defective, or mismatched connectors. The integration of real-time sensor data, closed-loop control algorithms, and database-driven decision-making reinforces the reliability and repeatability of the system, making it suitable for high-volume, high-precision manufacturing environments such as aerospace or medical device tubing assembly.

Yet, in another embodiment, the purging assembly (4) is further configured to regulate the backflow gas flow rate using a mass flow controller, wherein the flow rate is dynamically adjusted based on the welding parameters and the geometry of the weld joint to ensure optimal shielding and minimize oxidation; and employ a directed gas nozzle, wherein the directed gas nozzle is configured to precisely direct the backflow gas to the weld joint, ensuring that the gas is applied exactly where it is needed.

Yet, in another embodiment, the purging assembly (4) is further refined to incorporate an advanced gas regulation and delivery mechanism that ensures optimal shielding during welding, particularly for sensitive materials and complex weld geometries. Central to this embodiment is the integration of a mass flow controller (MFC), which governs the flow rate of the backflow shielding gas-commonly argon or a controlled inert gas mixture. The MFC is electronically controlled and operates in conjunction with real-time welding parameters such as arc current, welding speed, heat input, and joint geometry, all monitored via the system's central control panel. As these parameters fluctuate—for instance, during transitions between thin and thick-walled sections of a hose or when welding around irregular geometries—the control system dynamically adjusts the flow rate output of the MFC to maintain a consistent and effective gas envelope over the weld joint.

The MFC uses closed-loop feedback from embedded flow sensors and pressure transducers to maintain accuracy, typically within +1% of the setpoint, and is responsive to millisecond-scale variations. For example, if the welding torch slows down momentarily due to geometric complexities, the system recognizes the increased dwell time and correspondingly boosts the shielding gas flow rate to prevent atmospheric contamination during the longer exposure. Conversely, during faster weld sequences, the gas flow is reduced to prevent turbulence and gas wastage.

Complementing the MFC is a precision-engineered directed gas nozzle. Unlike conventional purging diffusers that distribute shielding gas broadly, the directed gas nozzle is designed with a focused outlet geometry, which can include a conical or slot-style tip optimized via computational fluid dynamics (CFD) simulations. This nozzle ensures the shielding gas is precisely targeted at the molten weld pool and adjacent heat-affected zone (HAZ). Its positioning is dynamically controlled using the system's multi-axis robotic framework, which maintains a constant standoff distance and angle relative to the weld joint, regardless of the torch's orientation.

Together, the dynamic gas flow regulation and focused nozzle delivery form a synchronized purging mechanism that maximizes shielding effectiveness, minimizes oxidation and porosity defects, and reduces inert gas consumption. This is especially critical in applications involving titanium, stainless steel, or duplex alloys, where even trace levels of oxygen or nitrogen can degrade weld integrity. This embodiment not only enhances weld quality and repeatability but also supports environmental and economic efficiency by optimizing resource usage through intelligent gas management.

In one of the above embodiments, the control panel (13) is further configured to store and execute welding procedure specifications (WPS) that include welding parameters such as current, voltage, wire feed speed, and gas flow rate, wherein the WPS are selected based on the material and geometry of the flexible hoses and connectors; and utilize a database of AWS standards, wherein the database is used to ensure all welds are performed to the correct standard.

In one of the above embodiments, the control panel (13) is further configured to serve as the central intelligence hub for storing, managing, and executing Welding Procedure Specifications (WPS), which are comprehensive digital profiles defining the essential welding parameters required for consistent and standard-compliant welds. These WPS files include key parameters such as welding current, arc voltage, wire feed speed, torch travel speed, shielding gas composition and flow rate, preheat and interpass temperatures, and torch oscillation profiles. The system utilizes material-specific and geometry-specific logic to select the appropriate WPS for each welding task. For instance, if the operator loads a stainless steel connector with a wall thickness of 1.2 mm onto a silicone-coated flexible hose, the control panel automatically queries the internal database to identify and apply a WPS optimized for such a configuration.

To enable this, the control panel is linked to a database that catalogs WPS documents in a structured format, often using XML or JSON schema, making them easily readable by the onboard control software. Each WPS entry includes metadata for material type, thickness range, joint type (e.g., butt, lap, T-joint), and welding position. Advanced lookup algorithms match real-time sensor inputs and operator selections to the corresponding WPS. Once selected, the parameters from the WPS are fed directly to the welding torch, wire feeder, and gas flow control modules, ensuring process repeatability and reducing human error.

Furthermore, the control panel incorporates a fully indexed and searchable database of American Welding Society (AWS) standards. This AWS database is used to validate the parameters defined in each WPS against internationally recognized best practices and quality requirements. For example, if a WPS is retrieved for a GTAW weld on an austenitic stainless steel tube, the system verifies whether the travel speed, arc energy, and shielding gas purity comply with AWS D1.6/D1.6M structural welding code for stainless steel. If discrepancies are detected, such as a gas flow rate below the minimum shielding requirement, the system generates an alert and either recommends parameter corrections or blocks the welding operation until the issue is resolved.

This embodiment ensures not only the technical consistency of every weld, but also compliance with industry certification standards, which is crucial in safety-critical applications such as medical device manufacturing, aerospace tube assemblies, and food-grade process piping. Moreover, by embedding the AWS standard reference within the control panel and automating the selection and enforcement of WPS, the system minimizes operator dependency, speeds up setup time, and ensures traceability of welding parameters for audit and quality assurance purposes.

In another embodiment, the cloud monitoring module is further configured to log welding parameters and operational data in real-time, wherein the data is transmitted to a cloud-based server for remote monitoring and analysis; generate alerts based on predefined thresholds for welding parameters, wherein the alerts are transmitted to designated personnel for immediate action; and allow for remote adjustment of welding parameters, and remote diagnostic control.

In another embodiment, the cloud monitoring module is further configured to function as an intelligent, interconnected data acquisition and remote control system that significantly enhances the oversight, traceability, and operational flexibility of the welding process. The module is engineered to continuously log all critical welding parameters—such as current, voltage, wire feed speed, travel speed, shielding gas flow rate, arc stability metrics, and thermal feedback from the weld zone—in real-time during the execution of each weld cycle. This data is collected from various sensors, actuator modules, and control subsystems integrated within the automated welding platform.

Once collected, the data is structured in time-series format and transmitted securely over an encrypted communication channel—typically using TLS or SSL encryption protocols—to a cloud-based server infrastructure. The system utilizes a high-frequency data streaming protocol such as MQTT or WebSocket to ensure low-latency transmission and real-time synchronization between the local welding controller and the cloud platform. The cloud server is designed to ingest, store, and process this operational data using a combination of SQL and NoSQL databases for structured and unstructured data, respectively, allowing for scalable data warehousing and historical analysis.

On the cloud server, the system employs threshold-based monitoring algorithms and rule-based engines to detect anomalies or deviations in welding parameters. For example, if the arc voltage exceeds the safe upper limit due to a misaligned connector or incorrect shielding gas composition, the system immediately triggers an alert. These alerts are pushed to designated personnel-such as quality control engineers, maintenance technicians, or production supervisors-through SMS, email, or mobile app notifications using push protocols. The alert message includes detailed diagnostics and contextual metadata, such as weld ID, timestamp, operator name, and the specific parameter that caused the fault.

In addition to passive monitoring, the cloud module enables active remote control capabilities. Authorized personnel can log into a secure web-based dashboard to view real-time welding data, modify welding parameters, upload new WPS profiles, or override local controls under strict security policies. For example, if a field engineer identifies that the wire feed rate is consistently underperforming in a specific production batch due to material variance, they can remotely adjust the wire feed parameters to optimize the weld quality without halting production.

Moreover, the cloud system supports remote diagnostic control through integration with onboard diagnostics modules. In the event of a system fault, the cloud interface allows for root cause analysis by accessing logs, sensor diagnostics, and subsystem health data. This feature drastically reduces downtime by enabling proactive maintenance and informed decision-making from remote locations.

Altogether, this embodiment creates a highly responsive, data-driven, and remotely operable welding ecosystem that supports predictive maintenance, continuous process optimization, quality assurance, and full traceability—all critical features for Industry 4.0-compliant manufacturing environments.

In another embodiment, the motorized wire feed axis (11) is further configured to employ a closed loop feedback system, wherein the closed loop feedback system ensures that the wire feed rate is maintained at the correct speed and employ a wire feed spool brake system, wherein the wire feed spool brake system is used to prevent wire overrun when the wire feed is stopped.

In another embodiment, the motorized wire feed axis (11) is further enhanced with a closed-loop feedback system designed to maintain precise control over the wire feed rate during the welding process. This system integrates a servo motor equipped with an encoder that continuously measures the actual rotational speed and displacement of the wire feed rollers. The feedback from the encoder is transmitted to the central control panel, which compares it against the target wire feed rate specified in the selected Welding Procedure Specification (WPS). A closed-loop control algorithm—typically a Proportional-Integral-Derivative (PID) controller—is used to dynamically adjust the motor's input voltage and torque in real time to eliminate any deviation between the actual and desired feed rates.

For example, during welding on a thick-walled stainless-steel connector, the WPS may demand a wire feed rate of 180 mm/min. If material resistance or motor slippage causes the actual rate to fall to 165 mm/min, the controller immediately senses the discrepancy via encoder feedback and increases the motor torque to restore the proper feed rate. This ensures consistent wire deposition, maintaining arc stability, weld bead profile, and preventing defects such as underfilling or wire stubbing.

To complement this precise control, the system also incorporates a wire feed spool brake mechanism that prevents wire overrun, especially critical during sudden stops or arc termination events. The brake system is electromechanically or pneumatically actuated and is automatically engaged when the wire feed motor decelerates or stops. Without such a braking mechanism, the rotational inertia of the spool could cause excess wire to uncoil, leading to wire tangling, spatter, or feed jams when welding resumes.

The spool brake mechanism can utilize a proportional braking system, where the braking force is varied based on spool diameter and remaining wire mass to maintain consistent tension. The coordination between the brake system and the closed-loop motor control ensures that wire delivery is smooth, accurate, and synchronized with the torch movement, thereby upholding weld quality and minimizing downtime due to wire feed interruptions. This embodiment is particularly advantageous in high-precision applications such as orbital welding or automated TIG welding of thin-wall tubing, where feed rate consistency is essential to achieving defect-free welds.

In another embodiment, the control panel (13) further comprising a real-time arc stability monitoring technique implemented to analyze arc voltage and current fluctuations to detect instability and automatically adjust welding parameters to maintain a stable arc, thereby preventing weld defects; a dynamic heat input control system connected to calculate and adjust the heat input based on real-time temperature feedback from a thermocouple positioned near the weld joint, ensuring consistent weld penetration across varying hose and connector materials; and a multi-layered security protocol that requires multiple levels of user authentication before allowing modification of critical welding parameters or stored WPS, preventing unauthorized changes.

In another embodiment, the control panel (13) is further augmented with intelligent subsystems designed to enhance weld quality, ensure process stability, and enforce system security. One such subsystem is a real-time arc stability monitoring technique that continuously evaluates arc voltage and current characteristics to detect instability during the welding process. This subsystem uses high-speed analog-to-digital converters (ADCs) to sample arc voltage and current at rates exceeding 10 kHz. The sampled data is processed using a digital signal processing (DSP) algorithm that evaluates waveform characteristics—such as peak-to-peak variance, frequency harmonics, and transient events like spatter bursts or arc dropouts. When the algorithm identifies patterns indicative of arc instability—such as high-frequency current oscillations or low-voltage dips caused by improper arc length or poor gas shielding—the system responds by automatically adjusting one or more welding parameters, such as wire feed rate, torch travel speed, or current amplitude, to restore arc stability in real time. This prevents common weld defects such as porosity, lack of fusion, or incomplete penetration.

Additionally, the control panel incorporates a dynamic heat input control system, which ensures consistent weld penetration regardless of material variation. This system uses a thermocouple strategically positioned near the weld joint to monitor localized temperature in real time. The system continuously recalculates this value and adjusts relevant welding parameters—like dwell time, wire feed rate, or current intensity—to maintain consistent energy delivery to the weld zone. For instance, if a highly conductive aluminum connector begins dissipating heat too rapidly, the system will detect a drop in thermocouple temperature and increase the current slightly to compensate, thus avoiding cold lap or under-penetration issues.

To safeguard these high-value control functions from unauthorized manipulation, the control panel also integrates a multi-layered security protocol. This protocol enforces user authentication through multiple levels of access control. At the most basic level, users must enter a unique ID and password. Higher privilege operations—such as modifying critical welding parameters or editing stored Welding Procedure Specifications (WPS)—require biometric verification (e.g., fingerprint or facial recognition) or a two-factor authentication process that includes a time-based one-time password (TOTP) sent to a registered device. User activity is logged with timestamps and role-based tags, enabling traceability and accountability in regulated environments.

Together, these enhancements to the control panel form a robust framework for intelligent, secure, and adaptive welding operations. The arc stability monitoring ensures real-time corrective action, the dynamic heat input control guarantees consistent weld quality across diverse materials, and the security system prevents unauthorized parameter manipulation—making the overall system suitable for high-precision, standards-compliant industrial applications such as automotive fuel line fabrication, medical catheter welding, and aerospace tube assemblies.

In another embodiment, the motorized R-axis (10) further comprising: a synchronized rotational velocity control, wherein the rotational velocity of the R-axis is dynamically adjusted in coordination with the X, Y, and Z axis movements, ensuring consistent weld bead placement on complex geometries; a backlash compensation technique, wherein the technique compensates for mechanical backlash in the R-axis drive system, improving positional accuracy and repeatability during rotation; a controlled deceleration sequence, wherein the R-axis decelerates smoothly at the end of each rotation to prevent workpiece displacement and maintain weld integrity.

In another embodiment, the motorized R-axis (10) is further refined with advanced control and compensation mechanisms to ensure precise rotational manipulation of the workpiece during the welding process, especially in applications involving circular or complex three-dimensional weld paths. At the core of this embodiment is the synchronized rotational velocity control system, which dynamically adjusts the rotational speed of the R-axis in real-time coordination with the translational movements of the X, Y, and Z axes. This synchronization is achieved through a centralized motion controller that calculates the optimal rotational velocity required to maintain a constant linear weld bead travel speed across the curved surface of the workpiece. For example, when welding a flexible hose to a circular metal connector, the R-axis adjusts its rotational speed in tandem with the forward movement of the Z-axis to ensure the arc follows the weld seam with consistent torch-to-workpiece speed, thereby preventing bead inconsistency, undercut, or overlap.

To address the inherent mechanical imperfections in gear-driven or belt-driven rotation systems, the R-axis is also equipped with a backlash compensation technique. Mechanical backlash, which is the slight lag or dead zone in gear response when changing rotational direction, can result in positional errors during fine welding operations. This embodiment uses an angular encoder in conjunction with torque sensors to measure the actual versus commanded position. A predictive compensation algorithm, typically based on system identification and inverse dynamics modeling, estimates the magnitude of backlash and inserts corrective overshoot or offset values during directional changes. This real-time correction drastically improves rotational positioning accuracy and repeatability, especially during weld operations requiring intermittent rotation or direction reversals.

Furthermore, to protect the integrity of the weld and prevent mechanical shocks that could displace or distort the workpiece, a controlled deceleration sequence is implemented. As the R-axis approaches the end of its programmed rotation path, the motion controller executes a predefined velocity ramp-down profile. This profile uses a cubic spline or trapezoidal velocity trajectory to reduce angular speed gradually, thus avoiding abrupt stops. The smooth deceleration not only prevents inertial displacement of the clamped hose or connector but also ensures the welding arc is extinguished cleanly without causing crater cracks or incomplete terminations at the end of the weld bead.

Collectively, these R-axis enhancements ensure highly accurate, repeatable, and stable rotational control during the welding of tubular, circular, or helical joints. This level of precision is particularly vital in industries such as aerospace, medical device manufacturing, and high-pressure fluid systems, where weld consistency, alignment, and fusion depth are critical to product safety and performance.

In another embodiment, the motorized Z-axis (7), Y-axis (8), and X-axis (9) are further configured to: utilize a predictive trajectory control technique, wherein the technique anticipates changes in welding parameters and adjusts axis movements in advance to maintain a consistent torch position and orientation; implement a vibration damping system, wherein the system actively dampens vibrations in the axes drive systems, minimizing weld defects caused by mechanical resonance; and employ a laser triangulation sensor feedback system, wherein the sensor provides real time feedback regarding the weld joint location, and the X, Y, and Z axis are adjusted based on that real time feedback.

In another embodiment, the motorized Z-axis (7), Y-axis (8), and X-axis (9) are further enhanced with advanced motion intelligence and sensor feedback systems to ensure precision torch guidance, especially critical in automated welding applications involving flexible hoses and connectors with variable geometries. The first enhancement is the implementation of a predictive trajectory control technique, which enables the system to anticipate changes in welding parameters—such as arc length, torch-to-surface angle, or weld speed—and adjust axis movement proactively rather than reactively. This is achieved using a real-time path planning algorithm that incorporates machine learning models and Kalman filtering to predict upcoming deviations in the weld path based on historical motion profiles and sensor inputs. For instance, if the system identifies a sudden curvature or flange transition in the connector geometry, it will adjust the axis velocities and interpolation paths to maintain a consistent standoff distance and orientation of the welding torch. This eliminates lag and overshoot, ensuring that the weld bead remains consistent and well-aligned even across varying topographies.

In tandem with predictive control, the axes are equipped with an active vibration damping system designed to counteract any mechanical oscillations or resonant vibrations originating from the drive motors, transmission components, or the machine frame itself. This system uses accelerometers mounted on the axis carriages to detect vibrational frequencies in real time. The data is processed by a digital signal processor (DSP), which actuates compensatory signals to piezoelectric actuators or adjusts servo motor inputs with phase-canceling commands. By suppressing low- and high-frequency vibrations, the system reduces motion-induced weld defects such as waviness, inconsistent bead profiles, or arc wander, especially during high-speed welding operations.

Additionally, the axes system employs a laser triangulation sensor feedback system, which plays a critical role in adaptive torch positioning. This sensor emits a coherent laser beam that reflects off the weld joint surface, and the reflected beam is captured at a known angle by a position-sensitive detector (PSD) or CMOS array. The resulting triangulation data is processed to calculate the exact 3D position of the weld joint in real time. This spatial feedback is continuously fed to the motion controller, which makes on-the-fly adjustments to the X, Y, and Z axis positions to compensate for part misalignments, surface warping, or variations in component placement. For example, if the hose connection point is 1.5 mm off from its expected location due to part tolerance, the laser sensor detects the deviation, and the controller adjusts the torch trajectory to maintain weld centerline accuracy.

Together, these capabilities form a highly adaptive and intelligent axis control system capable of executing complex weld paths with micron-level accuracy and dynamic response. This is especially valuable in high-mix, low-volume production environments—such as in custom medical tubing assemblies or aerospace ducting—where part-to-part variability is common, and precision is paramount. The combination of predictive control, vibration damping, and real-time laser feedback ensures consistent, defect-free welding under diverse and challenging operational conditions.

In another embodiment, the torch and wire feed holder kit (5) further comprising: a quick-change torch nozzle system that allows for rapid replacement of torch nozzles with varying geometries, facilitating welding of different hose and connector configurations; a dynamic wire guide adjustment system, wherein the wire guide position is automatically adjusted based on the welding wire diameter and feed rate, ensuring consistent wire delivery to the weld joint; and a collision detection system that detects potential collisions between the torch and workpiece, automatically halting axis movement to prevent damage.

In another embodiment, the torch and wire feed holder kit (5) is further configured with modular, adaptive, and safety-enhancing components that significantly streamline operation and improve welding reliability across a variety of hose and connector geometries. Central to this configuration is a quick-change torch nozzle system, which allows operators or the automated system to rapidly swap out torch nozzles of different shapes and sizes—such as conical, tapered, or wide-flare nozzles—without requiring extensive disassembly or manual realignment. This is achieved using a precision locking mechanism with spring-loaded detents or a cam-style retention collar that enables tool-less removal and reattachment of nozzles. The system recognizes the attached nozzle via an RFID or optical sensor tag, allowing the control panel to automatically adjust welding parameters (e.g., shielding gas flow or stand-off distance) to match the new geometry. This modularity greatly reduces downtime during production changes and facilitates rapid adaptation to varying weld joint configurations.

To complement this flexibility, the embodiment also includes a dynamic wire guide adjustment system, which ensures that the position of the wire guide is automatically optimized based on the wire's diameter and feed rate. This system uses a stepper motor or linear actuator to reposition the guide channel relative to the torch axis. The wire guide's location is calculated using real-time data on the wire diameter—input via the control panel or detected by a diameter sensor—and the programmed wire feed rate. For instance, when switching from a 0.8 mm stainless steel filler wire to a 1.2 mm aluminum wire, the system adjusts the guide's offset and angle to maintain proper alignment with the weld pool, minimizing spatter and arc instability. This level of precision ensures consistent wire delivery, reduces tip erosion, and improves bead profile uniformity.

Furthermore, the holder kit is equipped with an intelligent collision detection system, designed to prevent accidental impact between the torch and the workpiece or fixture. This system employs force-torque sensors and/or accelerometers mounted near the torch head to detect abnormal resistance or sudden deceleration indicative of a collision. Alternatively, a soft-touch sensor or capacitive proximity sensor may be used to detect nearing obstructions before physical contact occurs. Upon detecting a potential collision, the system immediately sends an interrupt signal to the motion controller, which halts all axis movements and retracts the torch to a safe position. This feature is especially critical during setup, path teaching, or when operating in environments where part tolerances or placements may vary unexpectedly.

Altogether, this embodiment enhances the torch and wire feed system's modularity, adaptability, and operational safety, ensuring reliable weld quality and protecting the equipment from physical damage. These features are particularly advantageous in flexible manufacturing environments where different hose types and connector designs must be processed rapidly and safely with minimal manual intervention.

In another embodiment, the HMI/touch screen (14) is further configured to display a real time 3D simulation of the welding process, wherein the simulation visually represents the torch position, wire feed, and weld bead deposition, providing the operator with a comprehensive view of the welding operation; enable voice command control, wherein the operator can use voice commands to initiate welding sequences, adjust parameters, and acknowledge alerts, improving operator efficiency and safety; and implement a customisable user interface, wherein the user can create and store custom layouts of the HMI, displaying only the parameters and controls relevant to their specific welding task.

In another embodiment, the HMI/touch screen (14) is further configured as an advanced, operator-centric interface that enhances situational awareness, operational control, and user adaptability during the automated welding process. A key feature of this embodiment is the real-time 3D simulation of the welding process, which graphically renders a virtual representation of the work environment. This simulation includes dynamic visualization of the welding torch position, wire feed trajectory, and real-time weld bead deposition on the hose-connector assembly. The simulation is driven by real-time data from the multi-axis motion system, wire feed encoder, and weld parameter sensors, enabling the graphical model to reflect actual operations with high fidelity. For instance, if the torch adjusts its orientation to accommodate a curved connector flange, the 3D simulation updates accordingly, allowing the operator to visually verify torch alignment, arc position, and bead continuity without needing direct line-of-sight or physical access.

To further streamline operator interaction, the system supports voice command control integrated via a speech recognition engine, such as one powered by neural network-based natural language processing (NLP) models. The operator can use predefined voice commands to execute essential functions like initiating or pausing welding sequences, modifying parameters such as current or wire feed speed, and acknowledging system alerts or maintenance notifications. For example, a technician working with gloved hands could say, “Increase wire speed to 160 millimeters per minute” or “Start pre-weld simulation,” and the system would interpret and execute the command with built-in confirmation prompts. This voice interface not only improves operational efficiency but also enhances safety by reducing the need for manual touch input in hazardous or high-contamination environments.

Another critical feature of this embodiment is the customizable user interface, which empowers operators to tailor the HMI layout based on their specific roles, preferences, or tasks. The interface allows drag-and-drop widget placement, the creation of profile-specific dashboards, and parameter grouping by relevance (e.g., gas settings, arc parameters, motion control, or diagnostics). For instance, a quality control operator may choose to display real-time arc voltage, bead profile metrics, and alert logs, while a maintenance engineer may prioritize axis drive health, lubrication schedules, and error codes. These custom layouts can be saved as user profiles and recalled on demand, streamlining workflow and reducing cognitive load by showing only the controls and data relevant to the user's immediate responsibilities.

Altogether, this embodiment transforms the HMI/touch screen from a passive display into an intelligent, interactive, and adaptive control center. By combining immersive 3D visualization, hands-free voice control, and user-defined interface customization, the system ensures more intuitive operation, faster response to process deviations, and enhanced situational awareness-benefits that are particularly valuable in high-mix, precision-focused manufacturing environments such as medical device assembly or aerospace tube system welding.

In another embodiment, the control panel (13) further comprising: a dynamic dwell time control, wherein the dwell time of the GTAW welding torch at each taught point is automatically adjusted based on real-time temperature feedback from a thermocouple positioned near the weld joint, ensuring consistent heat input and preventing overheating; a multi-tiered error handling protocol, wherein the protocol prioritizes and displays error messages based on severity, and automatically triggers a safe shutdown sequence in response to critical errors, minimizing potential damage and ensuring operator safety; and a dynamic arc length control, wherein the control panel adjusts the Z-axis position based on the real time arc voltage, and also based on the real time rotational position of the R axis, therefore ensuring that the arc length remains consistent even when the workpiece surface is not uniform.

In another embodiment, the control panel (13) is further configured with advanced adaptive control and safety mechanisms to enhance weld consistency, thermal regulation, and fault response. One such enhancement is the dynamic dwell time control, which intelligently adjusts the amount of time the Gas Tungsten Arc Welding (GTAW) torch remains at each taught position along the weld path. This control is governed by real-time feedback from a thermocouple sensor positioned near the weld joint. The thermocouple continuously reports temperature data to the control panel, which compares it to target thermal profiles defined in the selected Welding Procedure Specification (WPS). If the system detects a lower-than-expected temperature at a given weld point—such as in thicker or more thermally conductive areas—the control panel increases the dwell time to allow additional heat input. Conversely, if the thermocouple reports a rapid temperature rise nearing the maximum thermal threshold, the system shortens the dwell duration to prevent overheating, oxidation, or material warping. This thermal feedback loop ensures uniform heat distribution and penetration across varying hose and connector materials, reducing the likelihood of burn-through or insufficient fusion.

In addition, the control panel features a multi-tiered error handling protocol designed to prioritize operator safety and machine integrity. This protocol categorizes system alerts and faults into severity levels—such as informational, warning, and critical—and displays them on the HMI in color-coded formats for easy recognition. For example, a minor deviation in gas flow rate may generate a non-blocking warning with suggested corrective actions, while a loss of arc stability or actuator fault triggers a high-priority alert. In the event of a critical error, the control panel immediately initiates a safe shutdown sequence, which includes halting the arc, retracting the torch to a safe home position, and disabling all motion systems. This tiered approach prevents cascading faults, minimizes equipment damage, and reduces risks to personnel working nearby.

The system also includes dynamic arc length control, a real-time feature that ensures consistent arc length throughout the welding process—even when working with irregular or curved surfaces. This is accomplished by simultaneously analyzing real-time arc voltage data and the rotational position of the R-axis. Since arc voltage is directly proportional to arc length, fluctuations in voltage serve as an indicator of changes in standoff distance between the torch and workpiece. The control panel interprets these changes and adjusts the Z-axis position accordingly to restore the correct arc length. In scenarios involving rotational welds, the system factors in the angular displacement of the R-axis to preemptively compensate for surface height variations due to eccentricity or misalignment in the workpiece. This synchronized, dual-parameter control mechanism maintains optimal arc stability and fusion quality, particularly important when welding cylindrical, beveled, or non-uniform connector surfaces.

Together, these control panel enhancements create a tightly integrated environment for adaptive welding, thermal consistency, real-time fault recovery, and automated torch path correction. Such capabilities are essential for precision welding tasks in sectors like biopharmaceutical fluid handling, aerospace propulsion systems, and automotive emissions assemblies, where process consistency and safety cannot be compromised.

In another embodiment, the HMI/touch screen (14) is further configured to display a real-time graphical representation of the weld bead profile, wherein the profile is generated based on real-time data from a laser profilometer integrated into the torch and wire feed holder kit, providing immediate feedback on weld quality, thereby executes the taught welding path without activating the welding arc or wire feed, allowing the operator to verify the programmed sequence and identify potential collisions before actual welding and implement a user-configurable alarm system, wherein the operator can define custom alarm thresholds for critical welding parameters, and receive alerts via visual and auditory notifications when these thresholds are exceeded, wherein the HMI/touch screen (14) is further configured to: display the real-time graphical representation of the heat affected zone (HAZ), wherein the HAZ is calculated based on real-time temperature feedback and welding parameters, providing the operator with insights into the thermal impact of the welding process; enable a remote access control, wherein authorized users can remotely monitor and control the welding system via a secure network connection, facilitating remote troubleshooting and process optimization; and implement a user-configurable data logging system, wherein the operator can define custom data logging parameters and intervals, enabling comprehensive data collection and analysis for quality control and process improvement.

In another embodiment, the HMI/touch screen (14) is configured as an advanced visualization and control interface that provides comprehensive real-time insight into the welding process and enables customizable interaction with the system. One key feature of this embodiment is the real-time graphical representation of the weld bead profile, which is generated using high-resolution data from a laser profilometer integrated into the torch and wire feed holder kit. As the welding operation progresses, the profilometer continuously scans the weld bead surface, capturing measurements such as bead height, width, undercut, and reinforcement. This data is processed in real time and displayed as a dynamic, continuously updating 2D or 3D profile on the HMI. The operator can monitor this visual feedback to identify any deviations from the acceptable weld envelope—such as excessive convexity or surface irregularities—allowing for immediate intervention to prevent defect propagation.

To enhance pre-weld verification and reduce risk, the HMI is also configured to execute the programmed welding path without activating the arc or wire feed. This “dry run” or simulation mode traces the entire motion path of the torch and wire system while recording axis trajectories and verifying clearances against fixture and workpiece models. By doing so, the operator can visually detect potential collisions, misalignments, or undesired toolpaths in a safe, non-destructive manner prior to actual weld execution. This capability is especially valuable in high-precision or constrained environments where manual trial-and-error approaches would be too risky or time-consuming.

Additionally, the HMI includes a user-configurable alarm system, enabling operators to define custom thresholds for critical welding parameters such as arc voltage, current, travel speed, or gas flow rate. If these values exceed or drop below the defined ranges, the system issues immediate visual alerts (e.g., flashing icons, color-coded warnings) and auditory notifications (e.g., buzzers or spoken alerts) to prompt corrective action. This custom alarm mechanism ensures process control is tailored to specific materials, weld types, or quality standards and supports rapid operator response to prevent weld defects.

Further enhancing operational insight, the system provides a real-time graphical representation of the Heat Affected Zone (HAZ), calculated by combining real-time temperature feedback from thermocouples and inferred heat input values based on arc voltage, current, and travel speed. This thermal map is displayed adjacent to the weld bead simulation and allows the operator to understand how deeply and widely the base material is affected by the heat cycle. Such insight is critical for ensuring metallurgical integrity, particularly when welding heat-sensitive alloys or when minimizing grain growth and mechanical distortion is essential.

The HMI also supports remote access control, allowing authorized personnel to monitor and adjust welding operations from external locations via a secure network connection. This is facilitated through encrypted protocols such as VPN tunnels or HTTPS interfaces, ensuring data security while enabling remote troubleshooting, parameter tuning, and process optimization. For example, a quality engineer at a different facility can log in to view the welding dashboard, download logs, or modify WPS parameters as needed.

Finally, the interface implements a user-configurable data logging system, where operators can define which parameters to log (e.g., arc energy, axis positions, bead geometry), at what intervals (e.g., every second, per weld segment), and for what duration (e.g., per part, per batch). This granular control over data acquisition supports quality assurance programs, regulatory compliance, and root cause analysis. The logged data can be exported in formats compatible with statistical process control (SPC) software or enterprise resource planning (ERP) systems, enabling broader integration into manufacturing analytics platforms.

Altogether, this embodiment transforms the HMI into a central intelligence and visualization node that supports predictive quality control, customizable process management, real-time operational safety, and remote collaboration—key attributes for modern, smart manufacturing environments.

In another embodiment, the motorized wire feed axis (11) is further configured to: execute a dynamic wire feed retract sequence, wherein the retract distance and speed are automatically adjusted based on the real-time arc voltage and welding current, preventing wire sticking and ensuring smooth arc initiation; implement a wire feed oscillation control, wherein the wire feed axis is oscillated in synchronization with the torch oscillation, allowing for precise control of weld bead width and deposition rate; and utilize a wire feed tension control system, wherein the system regulates the tension applied to the welding wire, ensuring consistent wire feed and preventing wire slippage or breakage.

In another embodiment, the motorized wire feed axis (11) is further enhanced with intelligent motion coordination and adaptive control mechanisms to optimize wire delivery dynamics, arc initiation, and weld bead formation. A core feature of this embodiment is the dynamic wire feed retract sequence, which is executed at specific phases of the welding cycle, particularly during arc start and termination. The retract distance and speed are not fixed but are automatically adjusted in real time based on sensor inputs—specifically, arc voltage and welding current. These parameters serve as proxies for arc length and wire-to-workpiece interaction. For instance, during arc initiation, if the arc voltage is detected to be too low—indicating that the wire is too close to or contacting the workpiece—the system triggers a short, rapid wire retraction to avoid sticking and spatter. Conversely, if arc voltage is within optimal range, the system proceeds with a controlled, slower retract or none at all. This intelligent retraction avoids premature arc extinguishment and ensures a smooth transition into a stable weld, enhancing arc reliability and reducing electrode wear.

Another significant enhancement is the wire feed oscillation control, wherein the wire feed axis is dynamically oscillated—typically in a sinusoidal or triangular waveform—laterally in sync with the torch oscillation pattern. This synchronization is coordinated by the motion controller, which continuously aligns the phase and amplitude of the wire oscillation with the torch's movement across the weld joint. The combined motion enables the system to precisely control the weld bead width, improve filler distribution, and enhance penetration uniformity, particularly in fillet welds, multi-pass welds, or wide-groove joints. For example, when welding a thick-walled connector with a curved surface, the synchronized oscillation ensures the filler material is evenly deposited across both sides of the joint, reducing the risk of undercutting or incomplete fusion.

The embodiment also integrates a wire feed tension control system, which ensures that the tension applied to the welding wire remains consistent throughout the weld cycle, regardless of spool size, wire diameter, or environmental conditions. This system uses load cells or tension sensors positioned along the wire path, which continuously measure the mechanical force exerted on the wire. Based on this feedback, the control panel dynamically adjusts the drive motor torque or the pressure on the feed rollers to maintain optimal tension. Too much tension could lead to wire deformation or feed motor overload, while too little tension could result in wire slippage or inconsistent feed rates. This closed-loop tension control is particularly critical when working with softer wire alloys like aluminum or when transitioning between different wire diameters (e.g., from 0.8 mm to 1.2 mm), where tensile characteristics vary significantly.

Together, these features provide the wire feed subsystem with advanced adaptability, coordination, and control, enabling smooth arc starts, precise filler control, and consistent wire delivery across a range of welding conditions. These capabilities are particularly beneficial in high-specification environments such as aerospace tubing, medical-grade stainless steel assemblies, or automotive fuel line manufacturing, where precision, reliability, and repeatability of wire feeding are essential for weld quality and production efficiency.

In another embodiment, the auto pneumatic connector fixture assembly (3) further comprising: an integrated force sensor connected to the frame and configured to provide real-time feedback on the clamping force applied to the connector, and the control panel automatically adjusts the pneumatic pressure to maintain a consistent clamping force; a connector presence verification unit having a proximity sensor to confirm the presence of a connector before initiating the welding process, preventing accidental welding without a connector; and a connector alignment correction unit that analyzes real time feedback from a vision system, and automatically adjusts the fixture assembly to correct minor misalignments of the connector relative to the hose.

In another embodiment, the auto pneumatic connector fixture assembly (3) is further engineered with high-precision sensing and adaptive alignment capabilities to ensure secure, accurate, and verified positioning of the connector prior to welding. One integral feature of this embodiment is the inclusion of an integrated force sensor mounted directly onto the fixture frame, positioned to monitor the clamping force applied by the pneumatic actuators to the connector. This sensor—typically a strain gauge or piezoelectric force transducer—continuously relays force readings to the control panel. The system uses this real-time feedback to execute a closed-loop pneumatic pressure adjustment using a proportional valve. For instance, if thermal expansion or surface irregularities cause the actual clamping force to deviate from the preset optimal level (e.g., 150 N for a stainless steel connector), the control system dynamically modifies the actuator pressure to bring the clamping force back into the target range. This ensures that the connector is securely held without distortion, slippage, or crushing, particularly critical for thin-walled or high-precision components.

To prevent erroneous operation, the fixture assembly also incorporates a connector presence verification unit, which employs a non-contact proximity sensor—such as an inductive, capacitive, or optical type—positioned near the clamping site. This sensor detects the physical presence of the connector within the fixture before the welding sequence is allowed to commence. If the sensor does not confirm the presence of the correct part within the expected positional tolerance, the control panel locks out the torch activation and wire feed systems, thereby preventing welding without a connector in place. This safeguard protects against wasted consumables, equipment damage, and potential operator hazards resulting from dry-arc strikes.

Additionally, the embodiment includes a connector alignment correction unit powered by a vision-based feedback system. This unit utilizes one or more cameras or structured-light sensors mounted above or around the fixture, which capture high-resolution images or 3D point clouds of the connector relative to the hose. These images are processed using computer vision algorithms—such as edge detection, shape matching, or template recognition—to determine the spatial orientation and positional offset of the connector. If a minor misalignment is detected—for example, a rotational skew of 2° or a lateral offset of 1 mm—the control panel calculates the necessary correction and commands the fixture's micro-actuators or linear slides to reposition the connector in real time before the weld is initiated. This automated correction not only improves positional repeatability but also minimizes reliance on manual alignment steps, which are prone to error and variation.

By integrating force-sensing, presence verification, and automated visual alignment correction into the fixture assembly, this embodiment ensures that each welding operation begins with a properly positioned, securely clamped, and verified connector. Such capabilities significantly enhance weld quality, reduce defect rates, and streamline production workflows—making the system particularly well-suited for high-throughput, precision-critical industries such as aerospace tubing, medical fluid systems, and industrial hose assemblies.

In another embodiment, the purging assembly (4) is further configured to execute a dynamic gas flow rate adjustment, wherein the gas flow rate is automatically adjusted based on the real-time welding current and travel speed, ensuring optimal shielding gas coverage and minimizing oxidation thereby implements a gas flow leak detection system, wherein the system monitors the gas flow rate and pressure, and generates an alert if a leak is detected, preventing gas wastage and ensuring proper shielding and utilize a pulsed gas flow delivery, wherein the backflow gas is delivered in pulsed bursts, allowing for precise control of gas distribution and minimizing gas consumption, wherein the purging assembly (4) is further configured to: implement a dynamic gas pulse frequency control, wherein the frequency of the pulsed gas flow is automatically adjusted based on the real-time welding parameters and weld joint geometry, optimizing gas shielding and minimizing gas consumption; execute a post-weld gas cooling sequence, wherein the purging assembly continues to deliver a controlled flow of inert gas after the welding arc is extinguished, accelerating the cooling process and minimizing oxidation; and utilize a gas composition analysis, wherein the system utilizes a gas sensor to analyse the composition of the backflow gas, and will alert the operator to any deviations from the correct gas mixture.

In another embodiment, the purging assembly (4) is further configured with advanced, sensor-driven gas control mechanisms that ensure optimal shielding throughout the welding cycle, minimize oxidation, and enhance process efficiency. Central to this embodiment is the dynamic gas flow rate adjustment, which continuously modulates the flow of shielding gas in real time based on two key welding parameters: arc current and torch travel speed. The system monitors these parameters via embedded sensors and calculates the appropriate gas flow rate using a control algorithm, typically derived from empirical weld data and gas coverage models. For example, when welding at a higher current and slower travel speed—which typically results in a wider, hotter weld zone—the gas flow rate is automatically increased to provide adequate coverage and prevent atmospheric contamination. Conversely, during low-current or rapid passes, the flow rate is reduced to conserve gas without compromising shielding integrity.

To further support shielding quality and resource efficiency, the system also incorporates a gas flow leak detection system. This subsystem utilizes inline flow sensors and pressure transducers to continuously monitor the rate and pressure of gas delivery. If a discrepancy is detected—such as a rapid pressure drop or flow rate exceeding the calculated demand—it indicates a potential leak in the gas lines, torch assembly, or purge nozzle. The system responds by generating an immediate alert via the HMI, halting the weld operation if necessary to prevent weld failure, and logging the event for maintenance review. This proactive monitoring not only ensures weld quality but also reduces inert gas wastage and protects against costly production errors.

A main feature in this embodiment is the use of pulsed gas flow delivery, in which the shielding gas is dispensed in controlled bursts rather than a continuous stream. This technique allows for more targeted and efficient gas usage, particularly in welds with narrow joints or when intermittent gas coverage suffices. The system further enhances this feature through dynamic gas pulse frequency control, which adjusts the frequency and duration of each gas pulse based on real-time welding parameters and joint geometry. For instance, during a weld over a convex connector flange, the system may increase the pulse frequency to maintain consistent coverage across a changing surface, while reducing it during flat or less sensitive segments of the weld path.

Following arc termination, the system executes a post-weld gas cooling sequence, where a calibrated flow of inert gas—typically argon—is maintained for a specific period to shield the hot weld bead and adjacent heat-affected zone (HAZ) as it cools. This helps prevent post-weld oxidation and hydrogen absorption, which are critical concerns for stainless steel, titanium, or duplex alloys. The cooling duration and flow rate are automatically determined by real-time temperature data from thermocouples and the specific material profile stored in the WPS.

The purging assembly incorporates a gas composition analysis subsystem, which employs a gas sensor—such as a thermal conductivity detector (TCD) or non-dispersive infrared (NDIR) sensor—to verify the concentration and purity of the shielding gas being delivered. If the sensor detects contamination—such as oxygen intrusion or improper argon-to-helium ratio—it immediately alerts the operator and can suspend the weld sequence until corrective action is taken. This guarantees that the weld environment remains chemically stable and within specification, ensuring metallurgical integrity and compliance with welding standards.

In another embodiment, the control panel (13) is further configured to: perform real time weld quality analysis, wherein the analysis is done by monitoring the weld current, voltage, and rotational speed, and then comparing the real time data to the AWS standard data stored in the database, and then alerting the operator to any deviations; implement a recipe version control system, wherein the system tracks changes made to stored WPS and recipes, allowing users to revert to previous versions and ensuring traceability of welding parameters; and utilize a adaptive welding parameter adjustment system, wherein the system uses machine learning to adapt the welding parameters based on the real time data from previous welds, and uses that data to improve the quality of future welds.

In another embodiment, the control panel (13) is further enhanced with intelligent analytics and data management functionalities that elevate the system's capability for real-time quality assurance, historical traceability, and continuous process improvement. A prominent feature is the ability to perform real-time weld quality analysis, wherein the system continuously monitors key welding parameters—specifically weld current, arc voltage, and the rotational speed of the R-axis—during every weld cycle. These live parameters are compared against acceptable thresholds and tolerance bands derived from AWS (American Welding Society) standards, which are stored within the control panel's integrated database. For instance, if the current drifts outside the specified range for a given material thickness or if the rotational speed deviates from the defined envelope—potentially resulting in uneven bead formation—the system flags the issue in real-time and generates an alert via the HMI or connected alerting infrastructure. The operator is notified of the parameter deviation with contextual data, such as the exact location on the weld path and the deviation magnitude, enabling immediate corrective actions and preventing defective welds from progressing unnoticed.

To support regulatory compliance, process repeatability, and collaborative workflow in production environments, the control panel also implements a recipe version control system. This system maintains a versioned log of all changes made to stored Welding Procedure Specifications (WPS) and related process recipes, such as wire feed settings, gas flow profiles, or oscillation parameters. Each change entry includes metadata such as timestamp, user ID, machine ID, and the nature of the modification. This version history enables users to revert to earlier versions if a recent update negatively impacts weld quality or if historical process conditions need to be reconstructed for auditing purposes. For example, if an operator modifies a prequalified WPS for aluminum welding and subsequently encounters inconsistent bead penetration, they can roll back to a prior, validated version through the HMI without manual intervention or guesswork.

Additionally, the control panel features an adaptive welding parameter adjustment system, which leverages machine learning algorithms to analyze real-time and historical weld data to optimize future weld operations. This system utilizes a supervised learning model, such as a regression-based or decision tree algorithm, trained on input-output relationships between welding parameters (inputs) and quality indicators (outputs), including bead geometry, defect rates, or thermal stability. As welds are executed, the system continuously refines its predictive model using new data. Over time, the model learns to recognize correlations—such as how variations in wire feed speed affect arc stability under different gas compositions—and adjusts the upcoming welding parameters to optimize performance. For instance, if the model detects a pattern where lower torch travel speeds combined with specific rotational speeds result in better weld fusion for a certain connector geometry, it will suggest or automatically apply these optimizations for future welds.

This intelligent control architecture transforms the welding process from a static, manually tuned system into a self-correcting, learning-enabled environment that drives consistency, compliance, and operational efficiency. By integrating real-time quality analytics, version-controlled process management, and adaptive parameter tuning, the control panel ensures that the system can evolve with changing production needs while consistently delivering high-integrity welds suitable for aerospace, biomedical, and critical infrastructure applications.

In another embodiment, the control panel (13) is further configured to: implement a real-time welding parameter correlation technique, wherein the technique analyzes the correlation between arc voltage, welding current, wire feed rate, and rotational speed to identify optimal welding parameters for specific material combinations, and automatically adjust the welding parameters to maintain consistent weld quality; execute a dynamic weaving pattern control, wherein the weaving pattern of the GTAW welding torch is automatically adjusted based on the real-time temperature feedback and weld bead geometry, allowing for precise control of weld bead width and penetration; and utilize a pre-weld component thermal mapping system, wherein the system employs an infrared sensor to generate a thermal map of the components before welding, and adjusts the welding parameters based on the thermal map to compensate for variations in component temperature, thereby ensuring uniform weld quality.

In another embodiment, the control panel (13) is further configured with advanced analytical and adaptive control features that utilize real-time sensor data and thermal intelligence to dynamically optimize welding outcomes. One such capability is the real-time welding parameter correlation technique, which continuously monitors and analyzes interdependencies among critical process variables—namely arc voltage, welding current, wire feed rate, and the rotational speed of the R-axis. Using multivariate statistical models or machine learning correlation algorithms, the system identifies optimal parameter combinations specific to each material and joint configuration. For instance, in welding stainless steel connectors to flexible hoses, the system learns that maintaining a wire feed rate of 150 mm/min, current of 90 A, and a rotational speed of 12 RPM produces the most stable arc and uniform weld bead. If any parameter deviates—due to changes in material, geometry, or ambient conditions—the system adjusts the others accordingly in real-time to maintain the established equilibrium. This intelligent correlation mechanism prevents defect propagation caused by improper parameter combinations and ensures consistent weld quality across production batches.

The embodiment also supports dynamic weaving pattern control, where the movement pattern of the GTAW (Gas Tungsten Arc Welding) torch is automatically adjusted during welding based on real-time feedback. This feedback is sourced from temperature sensors (such as thermocouples or IR sensors) near the weld joint and from sensors monitoring the developing weld bead profile. The system analyzes bead width and depth in conjunction with thermal gradients and modifies the torch's oscillation pattern—such as switching between sine, triangle, or zigzag waveforms, or adjusting frequency and amplitude—in real time. For example, if the weld bead becomes narrower due to increased cooling or material thickness, the system widens the weaving pattern and increases dwell time at the bead edges to ensure proper sidewall fusion. This adaptability is crucial when welding variable-thickness hoses to metal connectors or performing multi-pass welds on dissimilar materials, where a fixed pattern would not suffice.

Further enhancing the adaptive capability is the integration of a pre-weld component thermal mapping system, which uses a non-contact infrared sensor to scan and analyze the temperature distribution of the hose and connector components before welding begins. This system generates a thermal map that visually and numerically indicates any residual heat zones, cold spots, or temperature inconsistencies across the weld region. Based on this thermal profile, the control panel adjusts initial welding parameters—such as preheat duration, arc current, and initial travel speed—to compensate for the thermal state of the materials. For instance, if the connector shows higher residual heat from a previous operation, the system may reduce initial current or accelerate the start of welding to avoid overheating and grain growth. Conversely, if the components are below optimal preheat levels, the system can trigger an extended pre-weld heating phase or modify arc initiation parameters accordingly.

In another embodiment, the motorized X-axis (9), Y-axis (8), and Z-axis (7) are further configured to implement a dynamic tool center point (TCP) calibration technique, wherein the technique automatically calibrates the TCP based on real-time feedback from a laser displacement sensor, ensuring accurate torch positioning and orientation throughout the welding process thereby execute a synchronized multi-axis motion control, wherein the movements of the X, Y, and Z axes are synchronized to maintain a constant torch travel speed and orientation, even when welding complex geometries and utilize a force feedback control system, wherein the system monitors the force applied by the torch to the workpiece, and automatically adjusts the axis movements to maintain a consistent contact force, thereby preventing damage to the workpiece and ensuring uniform weld penetration, wherein the auto pneumatic connector fixture assembly (3) is further configured to incorporate an integrated electrical continuity test, wherein the system verifies the electrical continuity between the connector and the fixture holder before welding, preventing welding on improperly grounded connectors thereby executes a dynamic clamping force profile, wherein the clamping force applied to the connector is automatically adjusted based on the real-time welding parameters and component temperature, preventing deformation of the connector during the welding process and utilize a real time vision system based connector alignment confirmation, wherein the system confirms the connector alignment, and also the correct part number of the connector, before beginning the weld.

In another embodiment, the motorized X-axis (9), Y-axis (8), and Z-axis (7) are further configured with a suite of precision control technologies aimed at maintaining highly accurate torch positioning, consistent motion synchronization, and adaptive force regulation during the welding of flexible hoses and metal connectors. At the heart of this configuration is the dynamic Tool Center Point (TCP) calibration technique, which utilizes real-time feedback from a high-precision laser displacement sensor mounted near the torch head. This sensor continuously measures the relative position between the torch and the workpiece surface, enabling the control system to dynamically recalibrate the TCP—defined as the precise point in space where the arc and filler material interact with the substrate. This recalibration accounts for any variations in fixture positioning, workpiece tolerance, or thermal distortion, ensuring that the torch remains properly oriented and positioned throughout the weld. The TCP is recalculated using triangulated sensor data and kinematic transformations that update the inverse kinematics model in real-time.

Building upon this precision, the system executes a synchronized multi-axis motion control scheme, whereby the X, Y, and Z axes operate in tight coordination to maintain a constant torch velocity and orientation, even over complex or non-linear weld geometries. The motion controller uses path-planning algorithms with jerk-limited velocity profiles and real-time position interpolation to ensure fluid, coordinated motion that avoids sudden accelerations or positional lag. For example, when welding along a curved hose surface or transitioning around a flared connector edge, the controller ensures that the arc length, travel speed, and orientation remain consistent to avoid bead waviness or penetration inconsistencies.

Additionally, the system incorporates a force feedback control system, which continuously monitors the contact force exerted by the torch or wire guide against the workpiece using force-torque sensors embedded within the torch mount or tool holder. If the system detects excessive force—which could damage thin-walled hoses or displace delicate connectors—it dynamically adjusts the Z-axis height or feed rate to reduce pressure. Similarly, if contact force falls below the required threshold for stable welding, the system compensates to maintain optimal engagement. This ensures uniform weld penetration, particularly critical in applications involving variable wall thicknesses or lightweight materials prone to mechanical distortion.

Extending beyond torch movement, the auto pneumatic connector fixture assembly (3) is further enhanced to include an integrated electrical continuity test, which verifies that the connector is properly grounded through the fixture before the welding arc is initiated. The system applies a low-voltage, high-frequency signal between the connector and the fixture frame, and measures impedance to confirm a continuous electrical path. If continuity is absent or unstable—due to improper clamping or material contamination—the welding cycle is halted, preventing arc misfires, incomplete fusion, or equipment damage.

Furthermore, the fixture assembly executes a dynamic clamping force profile, wherein the pneumatic pressure applied to the connector is modulated in real time based on welding parameters and component temperature. This is accomplished by integrating thermocouples and force sensors that monitor temperature rise and material expansion during welding. The control system adjusts the actuator pressure accordingly to maintain optimal clamping force—preventing deformation of heat-sensitive components while ensuring positional stability.

To complete this intelligent fixture configuration, the system also utilizes a real-time vision system-based connector alignment confirmation module. This module comprises a high-resolution industrial camera and image processing unit that scans the clamped connector and cross-references its geometry and surface markings with a database of stored part numbers. This dual-check ensures that the correct connector type is loaded and properly aligned relative to the hose before the weld begins. If the alignment falls outside the specified tolerance or the part ID does not match the scheduled job, the system alerts the operator and locks the welding sequence.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A gas tungsten arc welding (GTAW) system for automated welding of flexible hoses, comprising:
a frame having a pneumatic stopper assembly (2), pneumatically connected to an air supply, configured to position and secure flexible hoses for fusion welding at a user-defined location;
a wire feed spool (1), connected to the frame, configured to supply welding wire;
an auto pneumatic connector fixture assembly (3), pneumatically connected to the air supply and electrically connected to a control panel, comprising an EC copper-based fixture holder, the fixture assembly configured to align and secure connectors concentrically with fusion-welded hoses for wire feed welding, and controlled via an HMI/touch screen;
a purging assembly (4), fluidly connected to a gas source, configured to introduce a backflow gas into a weld joint between a connector and a fusion-welded hose during wire feed welding, thereby minimizing oxidation and discoloration;
a torch and wire feed holder kit (5), mechanically coupled to a motorized Z-axis, Y-axis, and X-axis, configured to position a GTAW welding torch and a wire feed adapter;
a fixture adapter (6), mechanically coupled to the auto pneumatic connector fixture assembly, configured to accommodate fixtures for connector assembly with varying diameters ranging from ¼ inch to 2 inches;
a motorized Z-axis (7), electrically connected to the control panel, configured to automatically position the GTAW welding torch along a vertical axis;
a motorized Y-axis (8), electrically connected to the control panel, configured to automatically position the GTAW welding torch along a horizontal lateral axis;
a motorized X-axis (9), electrically connected to the control panel, configured to automatically position the GTAW welding torch along a horizontal longitudinal axis;
a motorized R-axis (10), electrically connected to the control panel, configured to rotate a workpiece clamped in a chuck up to 600 degrees, facilitating welding, pre-purge, post-purge, overlap, and post-weld cooling processes;
a motorized wire feed axis (11), electrically connected to the control panel and mechanically coupled to the wire feed spool, configured to automatically position the wire feed for connector welding;
a tower lamp (12), electrically connected to the control panel, configured to indicate operational status, including welding and emergency stop conditions, using color indicators and a buzzer;
the control panel (13) comprising a programmable logic controller (PLC) further configured to:
control the movement of the motorized R-axis (10) to execute a variable rotational speed profile during the welding process, wherein the rotational speed is dynamically adjusted based on the angular position of the workpiece to maintain a consistent weld bead formation, thereby enabling the welding of complex geometries,
control the welding machine (15) to vary the welding current in real-time based on the angular position of the workpiece as determined by the motorized R-axis (10), thus ensuring uniform weld penetration and heat distribution across the weld joint, execute a pre-programmed welding sequence that includes dynamic adjustment of the motorized X-axis (9), Y-axis (8), and Z-axis (7) positions, wherein the adjustment is based on a taught welding path that defines a series of coordinate points and associated welding parameters, thereby enabling precise control of the GTAW welding torch, and control the motorized wire feed axis (11) to synchronize the wire feed rate with the movement of the GTAW welding torch, wherein the synchronization is achieved by correlating the wire feed rate to the instantaneous velocity of the X-axis (9), Y-axis (8), and Z-axis (7), thus ensuring consistent weld filler deposition;
a cloud monitoring module, configured to provide real-time monitoring of welding parameters and welded components;
wherein the HMI/touch screen (14) is electrically connected to the control panel, configured to enable user interface for program teaching and parameter settings; and
wherein the welding machine (15) is electrically connected to the control panel and mechanically coupled to the torch and wire feed holder kit, configured to perform gas tungsten arc welding (GTAW) welding operations.

2. The system of claim 1, wherein the pneumatic stopper assembly (2) further comprising:
a closed-loop pneumatic control system to maintain a constant clamping force on the flexible hoses, wherein the clamping force is monitored and adjusted in real-time to compensate for variations in hose diameter and material properties, thereby ensuring repeatable positioning.

3. The system of claim 1, wherein the auto pneumatic connector fixture assembly (3) further comprising a pressure regulation system that allows for adjustable clamping force on the connectors, wherein the clamping force is set based on the connector material and geometry to prevent deformation during the welding process and a sensor feedback loop to confirm the connector is in the correct location prior to welding, and will not allow welding to proceed if the connector is not in the correct location, wherein the sensor feedback loop is further configured to perform a pre-weld dimensional analysis of the connector using a laser micrometer, wherein the dimensional analysis is compared to stored connector specifications to verify dimensional accuracy, preventing welding on defective connectors and utilize an eddy current sensor to verify the material composition of the connector, wherein the material composition verification is used to select the correct welding parameters from the stored WPS, ensuring optimal weld quality.

4. The system of claim 1, wherein the purging assembly (4) is further configured to:
regulate the backflow gas flow rate using a mass flow controller, wherein the flow rate is dynamically adjusted based on the welding parameters and the geometry of the weld joint to ensure optimal shielding and minimize oxidation; and
employ a directed gas nozzle, wherein the directed gas nozzle is configured to precisely direct the backflow gas to the weld joint, ensuring that the gas is applied exactly where it is needed.

5. The system of claim 1, wherein the control panel (13) is further configured to:
store and execute welding procedure specifications (WPS) that include welding parameters such as current, voltage, wire feed speed, and gas flow rate, wherein the WPS are selected based on the material and geometry of the flexible hoses and connectors; and
utilize a database of AWS standards, wherein the database is used to ensure all welds are performed to the correct standard.

6. The system of claim 1, wherein the cloud monitoring module is further configured to:
log welding parameters and operational data in real-time, wherein the data is transmitted to a cloud-based server for remote monitoring and analysis;
generate alerts based on predefined thresholds for welding parameters, wherein the alerts are transmitted to designated personnel for immediate action; and
allow for remote adjustment of welding parameters, and remote diagnostic control.

7. The system of claim 1, wherein the motorized wire feed axis (11) is further configured to employ a closed loop feedback system, wherein the closed loop feedback system ensures that the wire feed rate is maintained at the correct speed and employ a wire feed spool brake system, wherein the wire feed spool brake system is used to prevent wire overrun when the wire feed is stopped.

8. The system of claim 1, wherein the control panel (13) further comprising:
a real-time arc stability monitoring technique implemented to analyze arc voltage and current fluctuations to detect instability and automatically adjust welding parameters to maintain a stable arc, thereby preventing weld defects;
a dynamic heat input control system connected to calculate and adjust the heat input based on real-time temperature feedback from a thermocouple positioned near the weld joint, ensuring consistent weld penetration across varying hose and connector materials; and
a multi-layered security protocol that requires multiple levels of user authentication before allowing modification of critical welding parameters or stored WPS, preventing unauthorized changes.

9. The system of claim 1, wherein the motorized R-axis (10) further comprising:
a synchronized rotational velocity control, wherein the rotational velocity of the R-axis is dynamically adjusted in coordination with the X, Y, and Z axis movements, ensuring consistent weld bead placement on complex geometries;
a backlash compensation technique, wherein the technique compensates for mechanical backlash in the R-axis drive system, improving positional accuracy and repeatability during rotation;
a controlled deceleration sequence, wherein the R-axis decelerates smoothly at the end of each rotation to prevent workpiece displacement and maintain weld integrity.

10. The system of claim 1, wherein the motorized Z-axis (7), Y-axis (8), and X-axis (9) are further configured to:
utilize a predictive trajectory control technique, wherein the technique anticipates changes in welding parameters and adjusts axis movements in advance to maintain a consistent torch position and orientation;
implement a vibration damping system, wherein the system actively dampens vibrations in the axes drive systems, minimizing weld defects caused by mechanical resonance; and
employ a laser triangulation sensor feedback system, wherein the sensor provides real time feedback regarding the weld joint location, and the X, Y, and Z axis are adjusted based on that real time feedback, and wherein the torch and wire feed holder kit (5) further comprising:
a quick-change torch nozzle system that allows for rapid replacement of torch nozzles with varying geometries, facilitating welding of different hose and connector configurations;
a dynamic wire guide adjustment system, wherein the wire guide position is automatically adjusted based on the welding wire diameter and feed rate, ensuring consistent wire delivery to the weld joint; and
a collision detection system that detects potential collisions between the torch and workpiece, automatically halting axis movement to prevent damage.

11. The system of claim 1, wherein the HMI/touch screen (14) is further configured to:
display a real time 3D simulation of the welding process, wherein the simulation visually represents the torch position, wire feed, and weld bead deposition, providing the operator with a comprehensive view of the welding operation;
enable voice command control, wherein the operator can use voice commands to initiate welding sequences, adjust parameters, and acknowledge alerts, improving operator efficiency and safety; and
implement a customisable user interface, wherein the user can create and store custom layouts of the HMI, displaying only the parameters and controls relevant to their specific welding task.

12. The system of claim 1, wherein the control panel (13) further comprising:
a dynamic dwell time control, wherein the dwell time of the GTAW welding torch at each taught point is automatically adjusted based on real-time temperature feedback from a thermocouple positioned near the weld joint, ensuring consistent heat input and preventing overheating;
a multi-tiered error handling protocol, wherein the protocol prioritizes and displays error messages based on severity, and automatically triggers a safe shutdown sequence in response to critical errors, minimizing potential damage and ensuring operator safety; and
a dynamic arc length control, wherein the control panel adjusts the Z-axis position based on the real time arc voltage, and also based on the real time rotational position of the R axis, therefore ensuring that the arc length remains consistent even when the workpiece surface is not uniform.

13. The system of claim 1, wherein the HMI/touch screen (14) is further configured to display a real-time graphical representation of the weld bead profile, wherein the profile is generated based on real-time data from a laser profilometer integrated into the torch and wire feed holder kit, providing immediate feedback on weld quality, thereby executes the taught welding path without activating the welding arc or wire feed, allowing the operator to verify the programmed sequence and identify potential collisions before actual welding and implement a user-configurable alarm system, wherein the operator can define custom alarm thresholds for critical welding parameters, and receive alerts via visual and auditory notifications when these thresholds are exceeded, wherein the HMI/touch screen (14) is further configured to:
display the real-time graphical representation of the heat affected zone (HAZ), wherein the HAZ is calculated based on real-time temperature feedback and welding parameters, providing the operator with insights into the thermal impact of the welding process;
enable a remote access control, wherein authorized users can remotely monitor and control the welding system via a secure network connection, facilitating remote troubleshooting and process optimization; and
implement a user-configurable data logging system, wherein the operator can define custom data logging parameters and intervals, enabling comprehensive data collection and analysis for quality control and process improvement.

14. The system of claim 1, wherein the motorized wire feed axis (11) is further configured to:
execute a dynamic wire feed retract sequence, wherein the retract distance and speed are automatically adjusted based on the real-time arc voltage and welding current, preventing wire sticking and ensuring smooth arc initiation;
implement a wire feed oscillation control, wherein the wire feed axis is oscillated in synchronization with the torch oscillation, allowing for precise control of weld bead width and deposition rate; and
utilize a wire feed tension control system, wherein the system regulates the tension applied to the welding wire, ensuring consistent wire feed and preventing wire slippage or breakage.

15. The system of claim 1, wherein the auto pneumatic connector fixture assembly (3) further comprising:
an integrated force sensor connected to the frame and configured to provide real-time feedback on the clamping force applied to the connector, and the control panel automatically adjusts the pneumatic pressure to maintain a consistent clamping force;
a connector presence verification unit having a proximity sensor to confirm the presence of a connector before initiating the welding process, preventing accidental welding without a connector; and
a connector alignment correction unit that analyzes real time feedback from a vision system, and automatically adjusts the fixture assembly to correct minor misalignments of the connector relative to the hose.

16. The system of claim 1, wherein the purging assembly (4) is further configured to execute a dynamic gas flow rate adjustment, wherein the gas flow rate is automatically adjusted based on the real-time welding current and travel speed, ensuring optimal shielding gas coverage and minimizing oxidation thereby implements a gas flow leak detection system, wherein the system monitors the gas flow rate and pressure, and generates an alert if a leak is detected, preventing gas wastage and ensuring proper shielding and utilize a pulsed gas flow delivery, wherein the backflow gas is delivered in pulsed bursts, allowing for precise control of gas distribution and minimizing gas consumption, wherein the purging assembly (4) is further configured to:
implement a dynamic gas pulse frequency control, wherein the frequency of the pulsed gas flow is automatically adjusted based on the real-time welding parameters and weld joint geometry, optimizing gas shielding and minimizing gas consumption;
execute a post-weld gas cooling sequence, wherein the purging assembly continues to deliver a controlled flow of inert gas after the welding arc is extinguished, accelerating the cooling process and minimizing oxidation; and
utilize a gas composition analysis, wherein the system utilizes a gas sensor to analyse the composition of the backflow gas, and will alert the operator to any deviations from the correct gas mixture.

17. The system of claim 5, wherein the control panel (13) is further configured to:
perform real time weld quality analysis, wherein the analysis is done by monitoring the weld current, voltage, and rotational speed, and then comparing the real time data to the AWS standard data stored in the database, and then alerting the operator to any deviations;
implement a recipe version control system, wherein the system tracks changes made to stored WPS and recipes, allowing users to revert to previous versions and ensuring traceability of welding parameters; and
utilize a adaptive welding parameter adjustment system, wherein the system uses machine learning to adapt the welding parameters based on the real time data from previous welds, and uses that data to improve the quality of future welds.

18. The system of claim 1, wherein the control panel (13) is further configured to:
implement a real-time welding parameter correlation technique, wherein the technique analyzes the correlation between arc voltage, welding current, wire feed rate, and rotational speed to identify optimal welding parameters for specific material combinations, and automatically adjust the welding parameters to maintain consistent weld quality;
execute a dynamic weaving pattern control, wherein the weaving pattern of the GTAW welding torch is automatically adjusted based on the real-time temperature feedback and weld bead geometry, allowing for precise control of weld bead width and penetration; and
utilize a pre-weld component thermal mapping system, wherein the system employs an infrared sensor to generate a thermal map of the components before welding, and adjusts the welding parameters based on the thermal map to compensate for variations in component temperature, thereby ensuring uniform weld quality.

19. The system of claim 1, wherein the motorized X-axis (9), Y-axis (8), and Z-axis (7) are further configured to implement a dynamic tool center point (TCP) calibration technique, wherein the technique automatically calibrates the TCP based on real-time feedback from a laser displacement sensor, ensuring accurate torch positioning and orientation throughout the welding process thereby execute a synchronized multi-axis motion control, wherein the movements of the X, Y, and Z axes are synchronized to maintain a constant torch travel speed and orientation, even when welding complex geometries and utilize a force feedback control system, wherein the system monitors the force applied by the torch to the workpiece, and automatically adjusts the axis movements to maintain a consistent contact force, thereby preventing damage to the workpiece and ensuring uniform weld penetration, wherein the auto pneumatic connector fixture assembly (3) is further configured to incorporate an integrated electrical continuity test, wherein the system verifies the electrical continuity between the connector and the fixture holder before welding, preventing welding on improperly grounded connectors thereby executes a dynamic clamping force profile, wherein the clamping force applied to the connector is automatically adjusted based on the real-time welding parameters and component temperature, preventing deformation of the connector during the welding process and utilize a real time vision system based connector alignment confirmation, wherein the system confirms the connector alignment, and also the correct part number of the connector, before beginning the weld.

20. A method for automated gas tungsten arc welding (GTAW) of flexible hoses using an automated welding system as claimed in claim 1, the method comprising:
positioning and securing a flexible hose at a user-defined location using a pneumatic stopper assembly pneumatically connected to an air supply;
supplying welding wire from a wire feed spool connected to the welding system frame;
concentrically aligning and securing a connector to the fusion-welded hose using an auto pneumatic connector fixture assembly comprising an EC copper-based fixture holder, the fixture assembly being pneumatically and electrically actuated via a control panel and a human-machine interface (HMI);
introducing a purging gas to a weld joint between the connector and the hose using a purging assembly fluidly connected to a gas source to minimize oxidation and discoloration during wire feed welding;
positioning a GTAW welding torch and wire feed adapter using a torch and wire feed holder kit mechanically actuated by motorized Z-axis, Y-axis, and X-axis stages;
adapting the fixture assembly using a fixture adapter to accommodate connector diameters ranging from ¼ inch to 2 inches;
automatically moving the GTAW welding torch along vertical, lateral, and longitudinal axes using motorized Z-axis, Y-axis, and X-axis actuators respectively, under control of the control panel;
rotating the clamped workpiece using a motorized R-axis up to 600 degrees to facilitate welding, purging, overlap, and cooling steps;
automatically positioning the wire feed using a motorized wire feed axis mechanically coupled to the wire feed spool;
indicating the operational status, including welding and emergency stop, using a tower lamp electrically connected to the control panel;
dynamically adjusting the rotational speed of the motorized R-axis based on the angular position of the workpiece to maintain consistent weld bead formation;
varying the welding current in real-time based on the angular position of the workpiece to ensure uniform weld penetration and heat distribution;
executing a pre-programmed welding sequence comprising coordinated movement of the X, Y, and Z motorized axes along a taught welding path defining coordinate points and associated welding parameters; and
synchronizing the wire feed rate with the instantaneous velocity of the X, Y, and Z axes to ensure consistent filler material deposition.
